(19) United States
(12) Patent Application Publication
(10) Pub. No.: US 2013/0305854 A1
(43) Pub. Date: Nov. 21, 2013

(54) Swing leaf actuator and mounting thereof

(71) Applicant: Dorma GmbH + Co. KG, Ennepetal (DE)

(72) Inventors: Thomas WILDFÖRSTER, Schwelm (DE); Michael HUFEN, Wuppertal (DE); Falko SCHWEITZER, Schwelm (DE)

(21) Appl. No.: 13/632,720

(22) Filed: Oct. 1, 2012

(30) Foreign Application Priority Data
Sep. 30, 2011 (DE) 10 2011 054 079.2

(51) Int. Cl. E05F 15/12

(52) U.S. Cl. CPC E05F 15/121
USPC 74/89; 29/428

(57) ABSTRACT

A swing leaf actuator has an output shaft and a drive mechanism with at least one drive portion. The drive mechanism is operatively connected to the output shaft to be driven in at least one direction. The output shaft has a connecting portion that is connected to a swing leaf. The output shaft is translationally movable along its axis of rotation. A method for mounting the swing leaf actuator includes inserting the drive mechanism into a housing of the swing leaf actuator. Components disposed on the output shaft in a torque-proof manner are aligned such that the output shaft is pushed into the components. The output shaft is inserted into the components to be torque-proof with respect to each other. A mounting device includes elements configured to align the output shaft with regard to the components disposed on the output shaft in a torque-proof manner.

### BACKGROUND OF THE INVENTION

1. Field of the Invention

The invention relates to a swing leaf actuator, adapted to move a connected swing leaf and an intended mounting of such a swing leaf actuator.

2. Description of the Related Art

Two embodiments are known for swing leaf actuators: Door closers and swing leaf operators. Door closers differ from swing leaf operators in that a door closer is able to move a connected swing leaf mostly in a mechanical manner in only one direction, mainly in closing direction. However, swing leaf operators generally have a motor drive and, if required, a mechanical closer portion. The motor drive and the closer portion move the connected swing leaf in respective opposite directions.

This action is realized in that an output shaft of the swing leaf actuator is directly operatively connected to the swing leaf to be moved, or indirectly via a transmission or an arm assembly. The swing leaf actuator is thus able to move or to pivot the connected swing leaf by the rotation of the output shaft. In this case, the output shaft extends essentially vertically to a longitudinal extension of the swing leaf actuator and namely in the direction of the height extension of the swing leaf actuator, on account of its usual installation.

Depending on a weight of the swing leaf, the output shaft and the components of the swing leaf actuator disposed thereon in a torque-proof manner, such as a toothed wheel or a cam disc, are exposed to enormous driving forces, respectively torques of the swing leaf actuator or of the swing leaf, as soon as a force is exerted on the latter from the outside for example by wind load or by a person. This is why the output shaft is usually welded to the components disposed thereon in a torque-proof manner, or is inherently integrally manufactured, for example by forging. Screwing is unfavorable, because the screws would loosen under operation and therefore might cause damage inside the swing leaf actuator. Leaving aside this fact, the output shaft, the components mounted thereon and the bearings required for the rotation-free reception of the output shaft in the housing of the swing leaf actuator, need to be assembled prior to being inserted into the housing. Therefore, the relative position of the components with regard to each other must be previously determined; subsequent modifications are not possible or are possible only at a very high technical expense and high cost (uninstalling the swing leaf actuator, exchange of the output shaft, including all components, and re-assembling the swing leaf actuator). This relates in particular to the output shaft, as a highly stressed component of the swing leaf actuator, if the output shaft has been deformed for example during operation.

In order for the swing leaf actuator to be installed with the four common installation types, namely swing leaf installation (swing leaf actuator is mounted onto a swing leaf to be moved by the actuator)/overhead frame installation (swing leaf actuator is affixed to a stationary component of the leaf arrangement, such as a leaf frame, lintel or the like, generally above the swing leaf the actuator is supposed to move) on the pull-side (access direction in the closing direction of the swing leaf, respectively on the side on which the door hinges of the swing leaf can be seen)/push-side (access direction in the opening direction of the swing leaf, respectively on the side on which the door hinges of the swing leaf cannot be seen), the output shaft of the actuator has a connecting portion at both ends, for example in the shape of respectively a square, for torque-proof mounting, for example a pivot arm of an arm assembly. In order to make said drive portions accessible for attaching other components, said portions protrude beyond the rest of the swing leaf actuator. In other words, the length of the output shaft, and not the rest of the swing leaf actuator, determines the maximum exterior dimensions of the swing leaf actuator along the longitudinal extension of the output shaft, namely the height of the actuator. The two protruding driving portions of the swing leaf actuator thus result in increasing the height of the rest of the swing leaf actuator, which is in contrast to the desire for visually less conspicuous, in particular sleek or flat swing leaf actuators.

### SUMMARY OF THE INVENTION

It is the object of the invention to at least reduce at least one of the above mentioned disadvantages.

The inventive swing leaf actuator has an output shaft and a drive mechanism. The drive mechanism comprises at least one drive portion, which includes respectively one component disposed on the output shaft in a torque-proof manner. By this component, thus associated to the respective drive portion, said portion is operatively connected to the output shaft and rotationally drives the output shaft in at least one direction. The drive portion is thus able to effect a rotation of the output shaft. The output shaft essentially extends vertically to a longitudinal extension of the swing leaf actuator. At least at one end, the shaft has a connecting portion configured to be rotationally and operatively connected to a swing leaf. This means, rotating the output shaft results in rotating, respectively in pivoting the respective swing leaf. According to one embodiment of the invention, the output shaft is disposed to be translationally movable in each of the components which are disposed thereon in a torque-proof manner, and namely along the axis of rotation, thus essentially perpendicularly with regard to the longitudinal extension of the swing leaf actuator. It is thus possible to displace the output shaft to the end of the swing leaf actuator and to have it protrude from the housing thereof, to which end the swing leaf to be connected or to be moved or an interposed transmission, such as an arm assembly, a chain drive, or the like is to be attached.

It is thereby possible to retract the other end of the output shaft into the swing leaf actuator, so as to preferably terminate flush with the housing thereof. Because the output shaft, compared to the state-of-the-art, can be shortened, on the one hand, the overall height of the swing leaf actuator can be reduced or minimized. On the other hand, material and cost can be saved thereby.

Furthermore, mounting the swing leaf actuator may be simplified and a potential subsequent exchanging of the output shaft may be made possible or simplified. In the best case scenario, mounting is simplified in that the output shaft is put in place once the swing leaf actuator is assembled. Initially the output shaft is inserted into a respective component to be torque-proof with regard to the component. Thereupon, the position of rotation of the arrangement with regard to the rest of the swing leaf actuator can be modified or adjusted by turning the output shaft about its axis. This is advantageous, if this component is a cam disc. Depending on the installation situation, the cam disc may now be turned such that the swing leaf actuator exerts the desired motive power on the connected swing leaf.

In addition, the cost intensive, integral configuration of the output shaft together with the one or more components, respectively the expensive, permanent interconnection of said components by welding or forging can be foregone. As the integral configuration is abandoned, the output shaft and the components may be manufactured from different, respectively perfectly adapted materials. As the permanent connection of the output shaft to the one or more components is likewise abandoned, the output shaft and the one or more components can be optimized with regard to the respective mechanical load, without having to consider whether or not the respective materials can be welded.

In a swing leaf actuator, in which the output shaft thereof has a connecting portion at only one end, namely protrudes from the swing leaf actuator only at this location, the output shaft may be completely inserted into the swing leaf actuator, for example for the purpose of transporting.

Advantageously, the torque-proof arrangement between the output shaft and the one or more components, disposed in a torque-proof manner thereon, is realized via positive engagement. This allows for simply pushing the output shaft and the one or more components together and a torque-proof connection is achieved.

Preferably the configuration of the at least one drive portion is based on cams and, within the framework of one embodiment of the invention, forms a first of the at least one drive portions. Accordingly, this first drive portion comprises a cam disc, disposed to be torque-proof on the output shaft and thus represents the above mentioned component. Furthermore, the drive portion comprises a pressure roller, disposed in a known manner to be parallel to the axis of rotation of the cam disc and to be freely rotatable. This drive portion furthermore comprises a tensioning device operatively connected to the pressure roller such that the tensioning device urges the pressure roller perpendicularly with regard to its axis of rotation against a running surface of the cam disc. As a result, the pressure roller rolls on and presses onto the cam disc in a known manner and is thereby able to effect a rotation of the cam disc. The drive portion is preferably configured to move the swing leaf in a question in closing direction.

The pressure roller is preferably received to be freely rotatable in a transmission component, which is essentially disposed to be movable perpendicularly to an axis of rotation of the cam disc and translationally in a housing of the swing leaf actuator. This circumstance allows for spatially separating the pressure roller from the above mentioned tensioning device.

The configuration of said first drive portion may likewise be based on toothed racks. In this case, the drive portion comprises a toothed wheel as a component, disposed on the output shaft in a torque-proof manner, and a piston. The piston is received in the housing of the swing leaf actuator to be guided and translationally movable towards the output shaft and away from the latter. In addition, the piston has a toothed portion, which essentially extends along its path of movement and meshes with the toothed wheel. Finally, a tensioning device is provided, which is operatively connected to the piston such that it urges the piston in the direction of the output shaft or away from the output shaft. It is by this urging force that the piston is displaced in a known manner, whereupon the rotation of the output shaft is effected via the teeth of the piston meshing with the toothed wheel.

The above mentioned tensioning device is preferably configured as a mechanical energy accumulator, for example in the shape of a coil spring.

Preferably within the framework of the invention, the above mentioned at least one drive portion forms a second drive portion. Said second drive portion comprises a motor, which is rotationally and operatively connected to the aforementioned component or to another component, which is disposed on the output shaft in a torque-proof manner. In other words, it is a motive drive portion having the same effect on the output shaft as the one of the above mentioned drive portions.

Preferably, the inventive swing leaf actuator has both one of the above described first and said second drive portions. In this case, the drive portions are operatively connected to the output shaft such that the output shaft is driven by the drive portions in opposite directions of rotation. In other words, the two drive portions operate in opposite directions with regard to each other and thus form a swing leaf actuator, which is adapted to turn, respectively to pivot the connected swing leaf in both directions.

In case of a cam drive, the above mentioned transmission component preferably bypasses the output shaft such that the pressure roller is disposed at a side of the cam disc facing away from the tensioning device. This allows for a particularly simple possibility to reliably position the pressure roller with regard to the cam disc.

Preferably the transmission component and/or the cam disc are/is disposed respectively with at least one portion between the components of the drive portions. As a result, it is possible to stationarily dispose the components along the axis of rotation of the output shaft in the housing of the swing leaf actuator by already provided rotary bearings, respectively bearing components, whereby the number of required construction parts is kept small. This goes hand in hand with the possibility of achieving an optimized flat design of the arrangement of components and cam disc.

Furthermore and preferably, the one or more components of the drive portion(s) is/are stationarily received in the housing in a direction parallel with regard to the axis of rotation of the output shaft, and therefore positioned with regard to the entire swing leaf actuator. They are thereby prevented from being moved along when the output shaft is translationally moved in relation to them, and are therefore prevented from suspending the aforementioned rotational and operative connection(s).

In the event bearing components are provided, they will be stationarily disposed in the housing of the swing leaf actuator. It is via said bearing components that the one or more components, which are disposed on the output shaft in a torque-proof manner, are disposed to be freely rotatable in the housing. In other words, the bearing components do not only serve for the rotational support, but also for the positioning of the one or more components, which means furthermore a relatively small number of structural components is required.

Preferably, in the event of two components with intermediate cam disc, a spacer is provided between said two components. In conjunction with the transmission component, not only the possibility is offered to keep the components at a predetermined distance from each other, but to provide guidance for the transmission component at the same time.

Preferably the output shaft of at least one of the above described swing leaf actuators, seen along its axis of rotation, has an exterior contour, which, along its extension, has a changing distance to the center of rotation of the output shaft. In other words, the output shaft has a non-circular cross-section and/or the center of the axis of rotation of the output shaft is located off-center, such that an eccentric rotation of the output shaft results. The respective component, which is disposed on the output shaft in a torque-proof manner, therefore has a corresponding interior contour, which is configured such that the respective component, with its interior contour at least in portions, is positively engaged in the exterior contour of the output shaft, such that the respective component is disposed to be torque-proof with regard to the output shaft. In other words, the interior contour of the component does not have to be necessarily configured (completely) complementary to the corresponding exterior contour of the output shaft.

Furthermore, the inventive swing leaf actuator has a device releasably immobilizing the output shaft in order to prevent it from moving along its axis of rotation. It is thereby possible to immobilize the output shaft in its final operating position with regard to the swing leaf actuator, respectively with regard to the arm assembly to be articulated, with regard to a gear to be coupled or with regard to the swing leaf to be coupled, in order to move the very same swing leaf. The releasability function allows for subsequently changing the operating position. In particular the swing leaf actuator, respectively the output shaft thereof may be adapted on-site to the desired type of installation.

The inventive swing leaf actuator may have a special attachment device with an attachment screw. A torque transmitting component, for example in the shape of a pivot arm or arm assembly, cylindrical gear or the like, is affixed in a torque-proof manner to the output shaft via such a screw, such that, even if the screw rotates in the unscrewing direction up to a predetermined degree, said torque transmitting component will be retained at the output shaft and remain disposed in a torque-proof manner thereat. In other words, the screw does not necessarily lose any of its restraining function. Such unscrewing may arise for example in the event of vibrations at the swing leaf actuator, swing leaf or the like. Said type of screw connection increases the safety of operating the swing leaf actuator.

Furthermore, the embodiment of the inventive swing leaf actuator allows for a very simple mounting method. Initially, the method comprises a step in which the drive mechanism is inserted into a housing of the swing leaf actuator. The one or more components to be disposed on the output shaft in a torque-proof manner (however not yet put in place) is/are aligned and immobilized in their alignment position in such a way that the output shaft can be inserted into said one or more components without encountering any major resistance, respectively that the components can be placed onto the output shaft one after the other. Immobilizing may be realized in that the aforementioned tensioning device initially remains functionally separate from the output shaft, in that a closer spring for example, as a special embodiment, is not able to urge a potentially provided pressure roller against said cam disc. In this position, the output shaft is to be inserted into the one or more components in a following step, whereby simultaneously the output shaft and the one or more components are disposed to be torque-proof with regard to each other. In other words, the output shaft can be subsequently uninstalled, which benefits the exchangeability of this highly stressed component of the swing leaf actuator. Finally, and if required, the above mentioned tensioning device needs to be activated by unblocking for example, such that the device becomes effective in the framework of the first drive portion.

When utilizing one of the above described cam-based swing leaf actuators, the method can be modified in that the step of inserting the drive mechanism into the housing is realized such that the tensioning device is prevented from urging the pressure roller against the cam disc. As a result the pressure roller cannot interfere with inserting the output shaft. In addition, following the step of inserting, the method comprises an additional step of inserting the tensioning device into the drive mechanism in such a way or a step of transferring the tensioning device in such a condition that the tensioning device urges the pressure roller against the cam disc. As a result, the tensioning device is able to correspondingly set the output shaft in rotation.

An alternative mounting method provides initially inserting the output shaft into the components which are to be affixed thereon in a torque-proof manner. Thereafter, or during this operation, at least the components which are disposed the furthest on the outside, are immobilized or blocked up to a predetermined degree, in order to prevent them from moving in relation to the output shaft along the axis of rotation of the output shaft. As a result, the other components disposed there between cannot be removed any more from the output shaft. The thus formed arrangement represents therefore a sort of output module, which can be manipulated and installed as a unit. The thus configured output module is therefore inserted into the swing leaf actuator in a last step. This solution is in particular suitable for swing leaf actuators, where the housing comprises two halves. This circumstance allows for inserting the output module into receptions for example for bearings of the output shaft and then to place and fasten the other housing half on top.

This method is preferably expanded in that, following the insertion of the output module into the swing leaf actuator, the above mentioned immobilization of the components, disposed the furthest on the outside to prevent them from moving in relation to the output shaft along the axis of rotation of the output shaft, is being released. This solution has the advantage of being able to move the output shaft more easily along its axis of rotation following the last step.

As an alternative or in addition, the above mentioned methods may furthermore include a step of releasably immobilizing the output shaft to prevent the output shaft from translationally moving along its axis of rotation. This fact allows for a traditional connection of arm assembly, gear, or of a rotation shaft of a swing leaf.

Furthermore, the invention relates to a mounting device. According to one embodiment of the invention, the mounting device is adapted to be utilized for one of the above described installation methods. The mounting device includes elements which are configured on the one hand to align the output shaft with regard to the components which are to be affixed thereon in a torque-proof manner, in that, as already described above; the output shaft can be inserted into the respective component, or can be moved into it. In other words, said elements preferably serve to rotate the output shaft in relation to the component to be respectively affixed thereon in a torque-proof manner. On the other hand, said elements are configured to move the output shaft, once aligned, through the respective component to be affixed thereon in a torque-proof manner, respectively to insert the output shaft into the component. In other words, rotating the output shaft in relation to the respective component is stopped or prevented. In other words and according to the invention, the elements have a dual function: aligning and pushing the output shaft in.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention will become apparent from the following description of preferred embodiments, in which:

FIG. 1 is a swing leaf actuator;

FIGS. 2a-2g are perspective partial views of the swing leaf actuator of FIG. 1, provided with an output shaft arrangement according to a first embodiment of the invention;

FIG. 3 is the swing leaf actuator of FIG. 2 in a sectional view;

FIGS. 4a-4b show the swing leaf actuator of FIG. 2 provided with an arm assembly and in two variants;

FIG. 5 is a modification of the swing leaf actuator of FIG. 4;

FIGS. 6a-6b are a door closer provided with an output shaft arrangement according to a third embodiment of the invention;

FIG. 7 is a flowchart of a method for mounting a swing leaf actuator according to a first embodiment of the invention;

FIG. 8 is an expanded variant of the flowchart of FIG. 7;

FIG. 9 is a flowchart of a method for mounting a swing leaf actuator according to a second embodiment of the invention;

FIG. 10 is a modification of the methods of FIG. 7 to FIG. 9;

FIG. 11 is a device for inserting, respectively displacing the inventive output shaft along its axis of rotation according to a first embodiment of the invention;

FIGS. 12a and 12b are a device for inserting, respectively displacing the inventive output shaft along its axis of rotation according to a second embodiment of the invention;

FIGS. 13A and 13B are a device that is modified compared to FIG. 12;

FIG. 14 is a device that is modified compared to FIG. 13; and

FIG. 15 is a device that is modified compared to FIG. 14.

### DETAILED DESCRIPTION OF THE PRESENTLY PREFERRED EMBODIMENTS

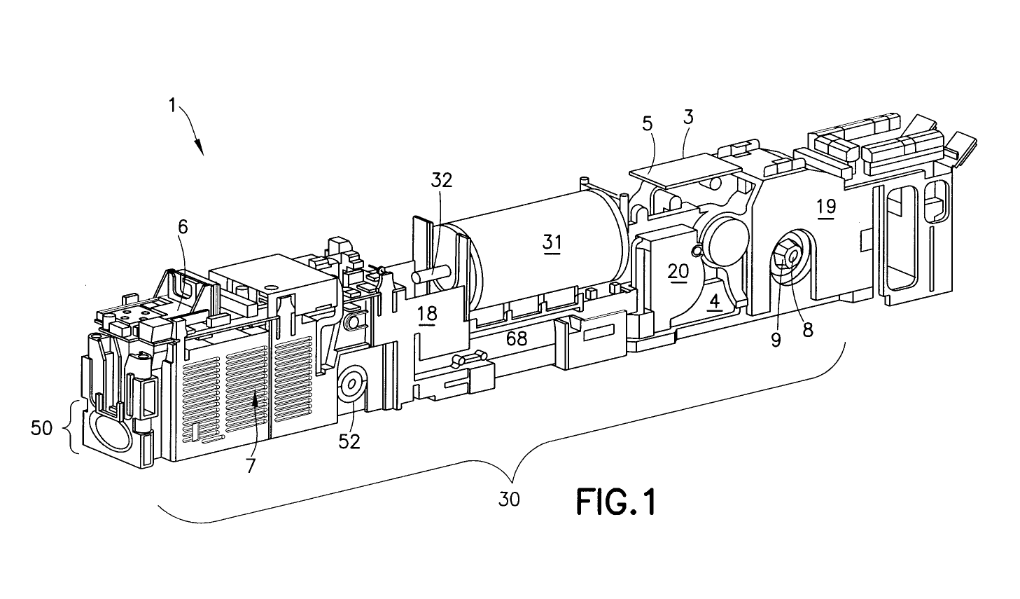

FIG. 1 shows a swing leaf actuator 1 which by way of example is configured as a swing leaf actuator 1. Essentially, the swing leaf actuator 1 comprises three components: a system carrier 18, adjacent thereto the drive mechanism configured by a drive portion 30 and a closer portion 50, and adjacent thereto a connecting component 19. At the top left side of FIG. 1, a control 6 for the swing leaf actuator 1 is mounted to the system carrier 18 and, in a known manner, serves for activating the swing leaf actuator 1. Below the control 6, a power supply unit 7 is pushed into the system carrier 18, which can be seen through slots in the system carrier 18 and serves for the energy supply to the electrical components of the swing leaf actuator 1.

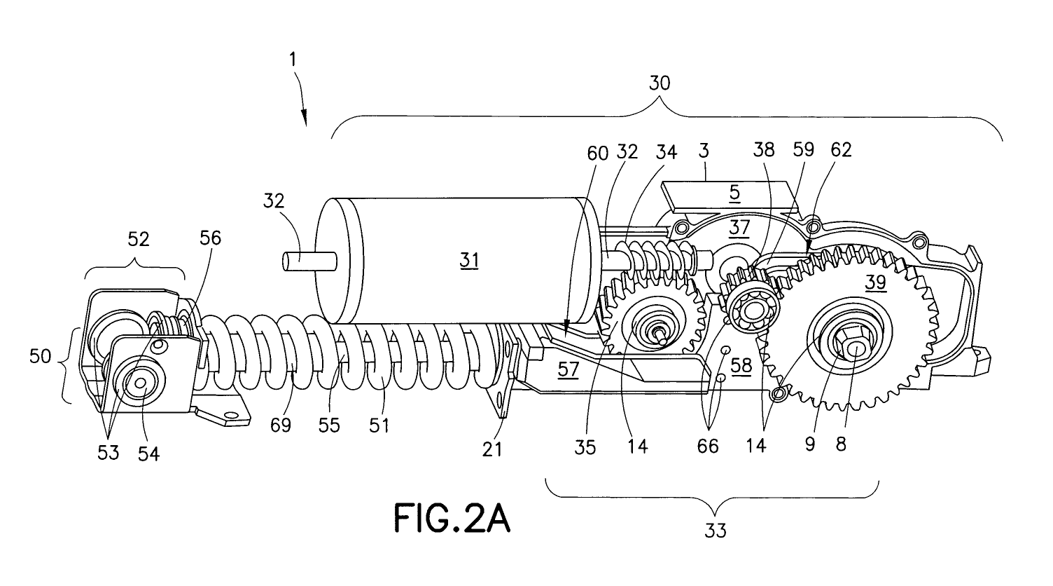

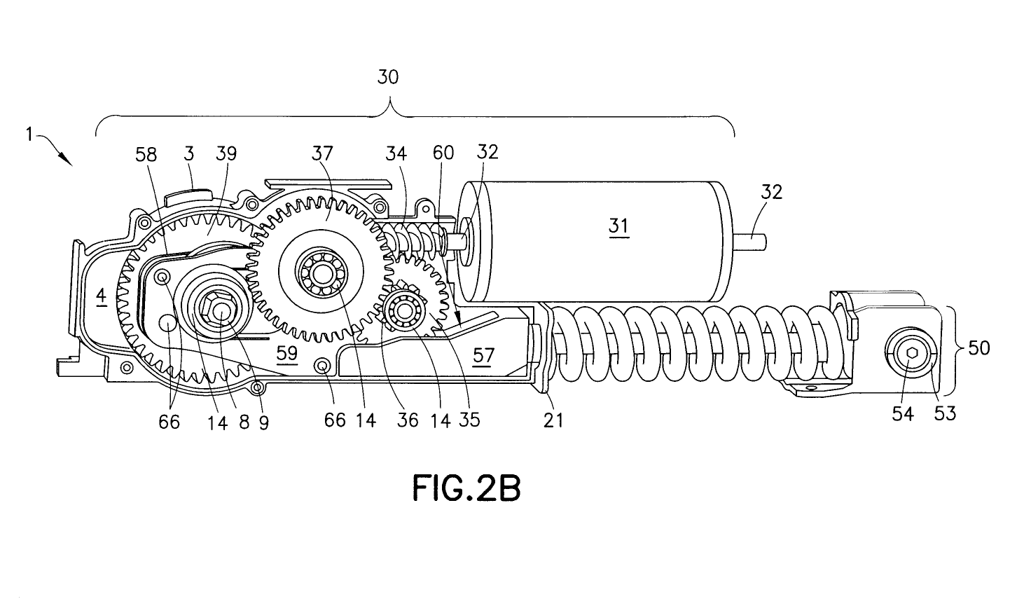

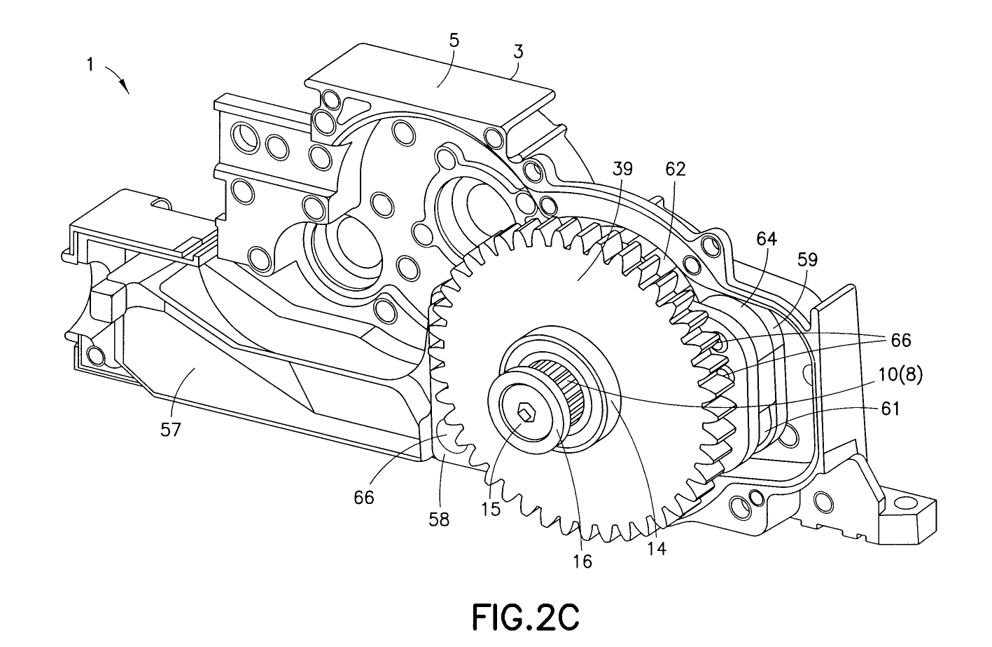

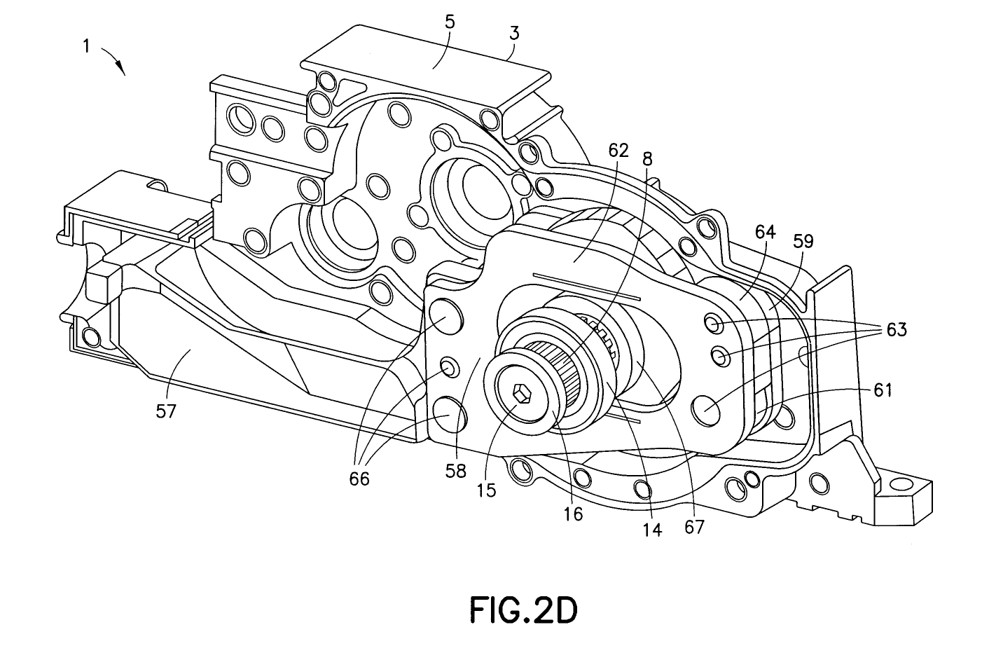

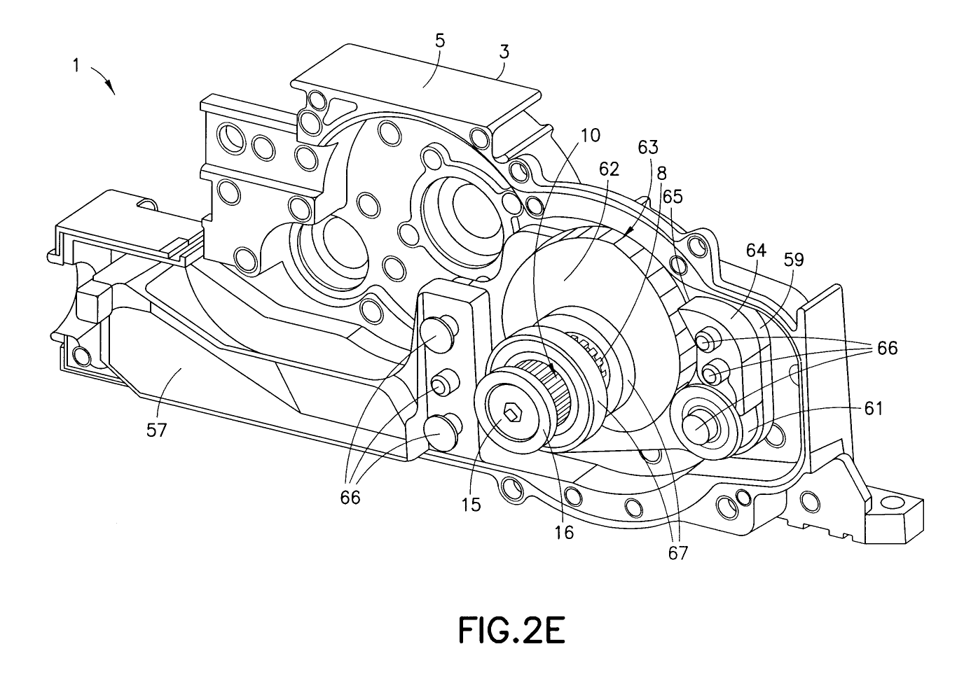

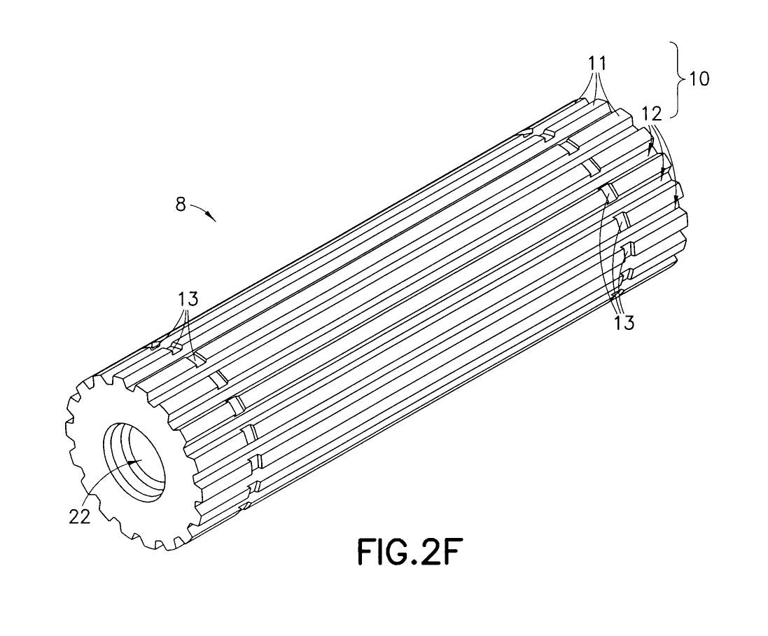

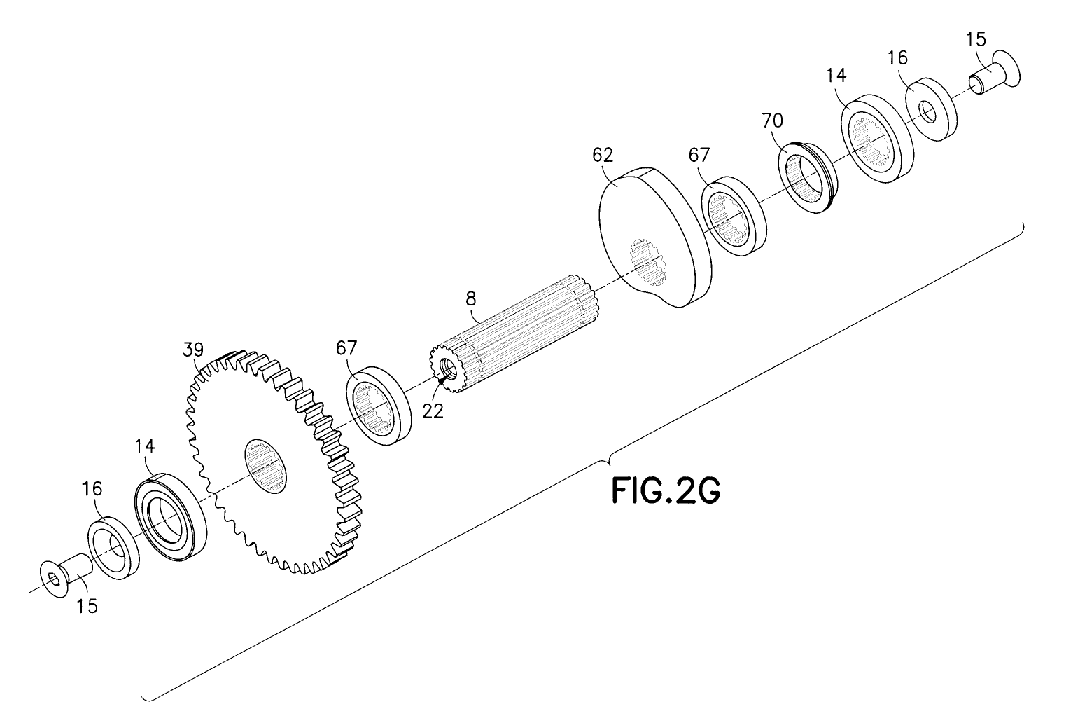

The drive portion 30 comprises a motor 31 with an output shaft 32 exiting on both sides by way of example. Via the output shaft 32 and via a gear 33, shown in FIG. 2a contained in a housing 3 of the swing leaf actuator 1, the motor 31 is rotationally and operatively connected to an output shaft 8 of the swing leaf actuator 1. By way of example, the housing 3 consists of half housings 4, 5, which are affixed to each other by non-identified screws for example, and accommodate all movable components. Furthermore, a position sensor 20, for instance in the shape of an incremental encoder, is placed on the housing half 4, the impulse disc thereof being advantageously disposed on a shaft of the gear 33 in a torque-proof manner, which gear 33 is accommodated in the housing 3.

The connecting component 19, located there behind and extending to the right side, is slid onto the housing 3 preferably in a latching and/or clamping manner, and serves for the connection, respectively reception of energy lines and/or data lines run to the outside. At both ends, the output shaft 8 has preferably a connecting portion 9, which in this case is configured by an external square. The closer portion 50 comprises a closer spring 51 shown in FIG. 2a accommodated in a spring tube 68. Furthermore, a mechanism 52 is provided for adjusting the pretension of the closer spring 51.

FIG. 2 shows the swing leaf actuator 1 of FIG. 1 in different partial views. In particular the system carrier 18 and the connecting component 19 are omitted in these views.

FIG. 2a shows the drive portion 30 and the closer portion 50, but not the housing half 4. In this case, the output shaft 32 of the motor 31 of the drive portion 30, exiting on both longitudinal ends is particularly well visible. A worm wheel 34, as a component of the aforementioned gear 33, is disposed at the right end of the output shaft 32 in a torque-proof manner and meshes with a first cylindrical gear 35, which is accommodated to be freely rotatably supported via associated bearings 14 in the housing 3, respectively the housing halves 4, 5 thereof. Not visible in this view, another cylindrical gear 36, which meshes with the sketchily recognizable cylindrical gear 37, is located behind, in this case, on the same shaft on which the cylindrical gear 35 is placed. The cylindrical gear 37 in turn is disposed on a shaft in a torque-proof manner on which a further cylindrical gear 38 is disposed to be torque-proof. Said cylindrical gear 38 in turn meshes with the last cylindrical gear 39, which is disposed on the output shaft 8 in a torque-proof manner. In this view, the connecting portion 9 in the shape of an external square is exceptionally well visible. Also, in this case, the two shafts on the right side for the cylindrical gears 37 to 39 are accommodated to be freely rotatably supported in the housing halves 4, 5 of the housing 3 via respective bearings 14. The drive portion 30 serves the purpose of driving the output shaft 8 in a first direction of rotation.

The closer portion 50 comprises the closer spring 51, which, on the right side, bears against a flange 21. On the left side, the closer spring 51 bears against a spring abutment 56. An adjustment mechanism 52 for adjusting the pretension of the closer spring 51 comprises three bevel wheels 53 meshing with each other, wherein two of them are opposite each other and are exposed on different faces of the swing leaf actuator 1, as is particular visible in FIG. 1. The last-mentioned two bevel wheels 53 either have a screw portion or they comprise a screwed-in screw 54, by which the respective bevel wheel 53 can be rotated. The bevel wheel 53 disposed between said two bevel wheels 53 meshes with them and, it is disposed to be torque-proof with regard to a collet 69. In this case, when rotating the bevel wheels 53, the collet 69 is screwed on the tensioning rod 55 or is unscrewed therefrom. It is thereby possible to move the spring abutment 56 to the left side, or to the right side in FIG. 2a, and thus to modify the pretension of the closer spring 51. The tensioning rod 55 passes through the flange 21, which is attached to the housing 3 or is integrally configured which the housing 3. On the right side of the flange 21, the tensioning rod 55 is secured to a cam plate carriage 57, which, in this case, runs below the cylindrical gear 35 to allow the latter to continue to freely rotate. The cam plate carriage 57 has an open recess 60 in this area and towards the cylindrical gear 35 in order to be able to run below the cylindrical gear 35. In this case via three bolts 66, the cam plate carriage 57 is operatively coupled to two cam plate halves 58, 59, respectively attached to them. As can be seen, the cam plate halves 58, 59 are disposed between the cylindrical gear 37 and the cylindrical gears 38, 39. Finally a cam disc 62, which will be explained later, can be sketchily seen behind the cylindrical gear 39.

Compared to FIG. 2a, FIG. 2b shows the swing leaf actuator 1 from the opposite side. This is why the housing half 5 is not illustrated, but instead the housing half 4. In this view, it is particularly well visible that the cylindrical gears 35, 36 are disposed in a torque-proof manner with regard to each other on one and the same shaft and that the cylindrical gear 36 meshes with the cylindrical gear 37. In addition, the bearings 14 are visible, by which the shafts (for example the output shaft 8) are likewise accommodated to be freely rotatably supported in the housing half 5. Bolts 66 are again visible, by which the cam plate halves 58, 59 are attached to each other, respectively to the cam plate carriage 57. In addition, it can be very well seen in what way the recess 60 allows the cam plate carriage 57 to get below the cylindrical gear 35.

The combined view of FIGS. 2a and 2b results in showing that, on both sides, the output shaft 8 is respectively provided with one connecting portion 9.

Compared to FIG. 2a, FIG. 2c shows a similar view, just from a right diagonal and without the constituents disposed on the left side of the housing 3, and, except for the cylindrical gear 39, without the gear 33 which is operatively connected to the motor 31. The output shaft 8 is slightly modified. In this case, the cam plate halves 58, 59, including a spacer 64 and a pressure roller 61, located behind the cylindrical gear 39. The pressure roller 61 is urged via the non-illustrated closer spring 51 and tensioning rod 55 to the left side in FIG. 2c, and therefore urged or pressed against the sketchily recognizable cam disc 62. The cam disc 62, together with the cylindrical gear 39 is disposed on the output shaft 8 in a torque-proof manner. A screw 15 is visible, by which a disc-shaped cover part 16 is attached to the one associated end of the output shaft 8. Seen along a common axis of rotation of the cylindrical gear 39, respectively of the output shaft 8, one of the bearings 14 is located in front of the cylindrical gear 39. In this embodiment, the output shaft 8 has an external toothing 10, which will be explained later. Each of the components to be installed in a torque-proof manner on the output shaft 8 has therefore a complementary interior contour corresponding preferably to said exterior contour of the output shaft 8, such that the components reach a positive engagement with the output shaft 8. The bearing 14 is configured such that an outer ring thereof bears against the non-illustrated housing half 4, and an inner ring of the bearing 14, and therefore the bearing 14 engages inside with the output shaft 8, such as to allow the output shaft 8 to freely rotate. Such an arrangement consisting of bearing 14 and output shaft 8 is likewise located at the other, non-visible side of the housing half 5 of the housing 3. Furthermore, bolts 66 are visible, which serve to attach either the cam plate carriage 57 to the cam plate halves 58, 59 or to attach the cam plate halves 58, 59 to each other and, if required, serve as an axis of rotation for the pressure roller 61.

FIG. 2d is an illustration similar to FIG. 2c, without the cylindrical gear 39. A spacer 67 is disposed between the non-illustrated cylindrical gear 39 and the cam disc 62. The spacer serves the purpose of creating a distance between the cylindrical gear 39 and the cam disc 62, which distance is dimensioned such that, in this case, the frontal one of the cam plate halves 58, 59 can be freely moved to the right and to the left sides in the thus generated interspace in FIG. 2d. For the cam plate half 59, a similar second spacer 67, not visible due to the cam disc 62, is located between the cam disc 62 and another likewise not visible spacer 70 which is disposed directly there behind. Furthermore, the spacer 67 preferably serves, in this case, to guide the frontal cam plate half 58 along its path of movement.

FIG. 2e shows the arrangement of FIG. 2d without the frontal cam plate half 58. It is in particular visible that the pressure roller 61 rolls on the associated running surface of the cam disc 62. The spacer 64 serves the purpose of keeping the cam plate halves 58, 59 in conjunction with the cam plate carriage 57 spaced apart from each other such that both the pressure roller 61 and the cam disc 62 are able to freely rotate between them. The spacer 64 has furthermore a pointed projection in the left upper area. This projection preferably serves as an abutment 65 for the cam disc 62.

The cam disc 62, as in particular illustrated in the hereafter described FIG. 2g, has by way of example a heart-shaped (cardioid) cross-section, which is definitely non-circular. The heart point 63, as the location the furthest remote from the center of rotation of the output shaft 8, diagonally points to the top right in FIG. 2e. If the connected swing leaf is opened for example, and rotates the cam disc 62 thereupon clockwise in FIG. 2e, at one point in time, the heart point 63 comes to bear against the abutment 65. Thereafter, a further clockwise rotation of the cam disc 62 is no longer possible. This position of the cam disc 62 preferably corresponds to a maximum possible opening angle of the swing leaf. Said arrangement represents a particularly simple and effective solution to prevent the cam disc 62 from rotating too far.

The heart shape of the cam disc 62 is configured in that the external circumferential surface, which extends parallel to the axis of rotation of the cam disc 62 and serves as the running surface for the pressure roller 61, reduces its distance to the axis of rotation, descending from the heart point 63. As the pressure roller 61 is pressed to the left side in FIG. 2e, this results in the cam disc 62 being rotated thereby counter-clockwise. Consequently, the non-illustrated drive portion 30 is configured in that it rotates the cam disc 62 in clockwise direction, namely opposite the direction of action of the pressure roller 61.

FIG. 2f shows the output shaft 8 in enlarged details. As indicated above, in the illustrated example, the output shaft 8 has an external toothing 10, the teeth 11 thereof and the tooth spaces 12 extending along the axis of rotation of the output shaft 8. In order to prevent the output shaft 32 from moving too far into the here non-illustrated housing 3, preferably all teeth 11 preferably have a respective groove-shaped recess 13 at both ends. The recesses 13 extend essentially perpendicularly to the axis of rotation of the output shaft 8 and have preferably identical distances to the respective next frontal end of the output shaft 8. As a result, a respective ring-shaped groove is created at the exterior circumference of the output shaft 8 into which a retaining ring can be inserted. This arrangement is very easy to realize and in addition very inexpensive. In particular, a retaining ring is easy to remove if the output shaft 8 is to be moved translationally. In addition the output shaft 8 has preferably at both ends a respective one or a single continuous internal thread portion 22. Said portion serves for screwing in the above-mentioned screw 15.

FIG. 2g shows the arrangement of the fully floating axle, respectively of the output shaft 8 in conjunction with the components illustrated in the previous Figures in an exploded view. The cam disc 62 has preferably an interior contour which is complementary to the exterior contour of the output shaft 8. As an alternative, only at certain locations the disc has teeth portions projecting to the inside that engage into some of the aforementioned tooth spaces 12, here not identified, of the output shaft 8. On the right side and the left side of the cam disc 62 two spacers 67 are disposed, which are preferably likewise provided with a corresponding female toothing for a positive engagement with the output shaft 8. The interior contours are namely configured to likewise reach a positive rotational engagement with the output shaft 8. Both spacers 67 have the function of creating a distance between the cam disc 62 and the cylindrical gear 39, respectively the right spacer 70, which guarantees free movement of the respective non-illustrated cam plate half 58, 59 past the illustrated arrangement, in this case. Another spacer 70 is thus adjoining the spacer 67. The spacer 70 has the function of filling the distance between the adjoining spacer 67 and the bearing 14, disposed on the right side in this case and likewise provided with an internal toothing. As an alternative, said two spacers 67, 70 directly adjoining each other are configured to be integral. Again as an alternative, the respective spacer 67, 70 may be likewise configured integrally with the bearing 14, respectively with the cam disc 62. Separating the two spacers 67, 70 from each other has the advantage of being able to utilize standardized spacers 67. This circumstance allows in particular for the possibility of utilizing shared components for the above described guidance of the cam plate halves 58, 59, in this case, even though the distance which exists between the cam disc 62 and the cylindrical gear 39 is different from the one between the cam disc 62 and the right bearing 14.

Said bearing 14 adjoins the right side of the spacer 70 such that the output shaft 8 is accommodated to be freely rotatable in the non-illustrated housing 3.

The aforementioned cylindrical gear 39 adjoins the left side of the left spacer 67. Again a second bearing 14 is disposed on the left side of the cylindrical gear 39, which in the illustrated example, does not have an interior contour complementary to the output shaft 8, but is instead preferably smooth on the inside. In other words, the output shaft 8 is able to slide through the bearing 14. Obviously it is possible to configure the left bearing 14 like the right bearing 14. By this arrangement, the output shaft 8 is accommodated to be rotatable and translationally movable at any time in the swing leaf actuator 1. In order to cover the output shaft 8 to the outside, it has the above described one or more internal thread portions 22 into which a respective screw 15 is screwed. In the illustrated example the screws 15 are countersunk screws, which immobilize a respective cover part 16 at the output shaft 8.

As an alternative, the countersunk screw 15 and the associated cover part 16 are configured integrally. In this case, a hexagon screw for example would be a good choice.

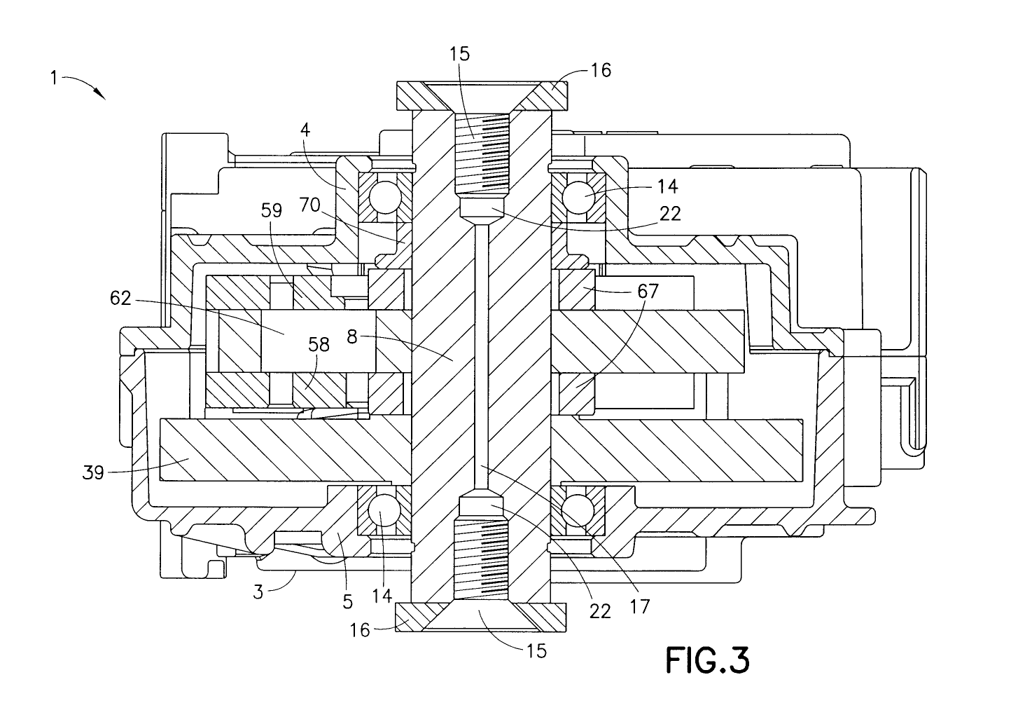

FIG. 3 shows the swing leaf actuator 1 of FIG. 2 in a section perpendicularly to the longitudinal extension of the swing leaf actuator 1 and in the installed condition. The bearings 14 provided for the cam disc 62 and the cylindrical gear 39 are inserted into the housing 3, respectively into an associated housing half 4 or 5 in such a way that they bear against interior sides respectively interior surfaces of the housing 3 which face each other. Furthermore, the spacers 67 are illustrated. The illustrated condition preferably represents the shipping condition of the swing leaf actuator 1. The screws 15, in conjunction with the cover parts 16, prevent the swing leaf actuator 1 from being operatively connected to a swing leaf, and mainly serve as a protection against losing the output shaft 8 and furthermore preferably as a protection against soiling the components accommodated in the swing leaf actuator 1. The cover part 16 is preferably configured to meet visual requirements.

In addition the internal thread portions 22 are visible. They are preferably configured in that they define a maximum length of thread engagement of the respective screw 15. In this illustration, the function of the spacer 70 becomes obvious. The bearings 14 both serve as the freely rotatable support bearing of the output shaft 8 in the housing 3 and the support of the components 39, 62, and 67 disposed between the bearings 14 and on the output shaft 8. In other words, the bearings 14 define the maximum construction height for the components 39, 62, and 67 to be accommodated on the output shaft 8. The cam plate halves 58, 59 are guided along the spacers 67, as described above, in this case into the plane of the drawing. The freely rotatable cam disc 62 is located between the cam plate halves 58, 59. In addition, the cam disc 62 preferably serves to guide the cam plate halves 58, 59 along the cam disc 62, namely forms a type of lateral guidance for the cam plate halves 58, 59. The cylindrical gear 39 is disposed below the cam plate half 58, i.e. at the side facing away from the cam disc 62. On the side opposite to the cam disc 62, the cylindrical gear 39 is supported in this case at the lower bearing 14. A hollow space exists to the top side between the upper spacer 67 and the upper bearing 14. In order to avoid now that the spacer 67 has to fill the relatively large interspace and fulfill the supporting function with regard to the cam plate half 59, the above mentioned additional spacer 70 is provided. The spacer 70 is configured in that it leans against both the upper bearing 14 and against the upper spacer 67. The upper spacer 67 can thereby reliably be prevented from moving in the direction of the upper bearing 14.

A recess, which by way of example is filled with lubricant 17, is provided in the output shaft 8 between the internal thread portions 22 and preferably interconnects the two. When connecting an arm assembly 80 or the like, the lubricant 17 reduces friction losses and therefore potential wear.

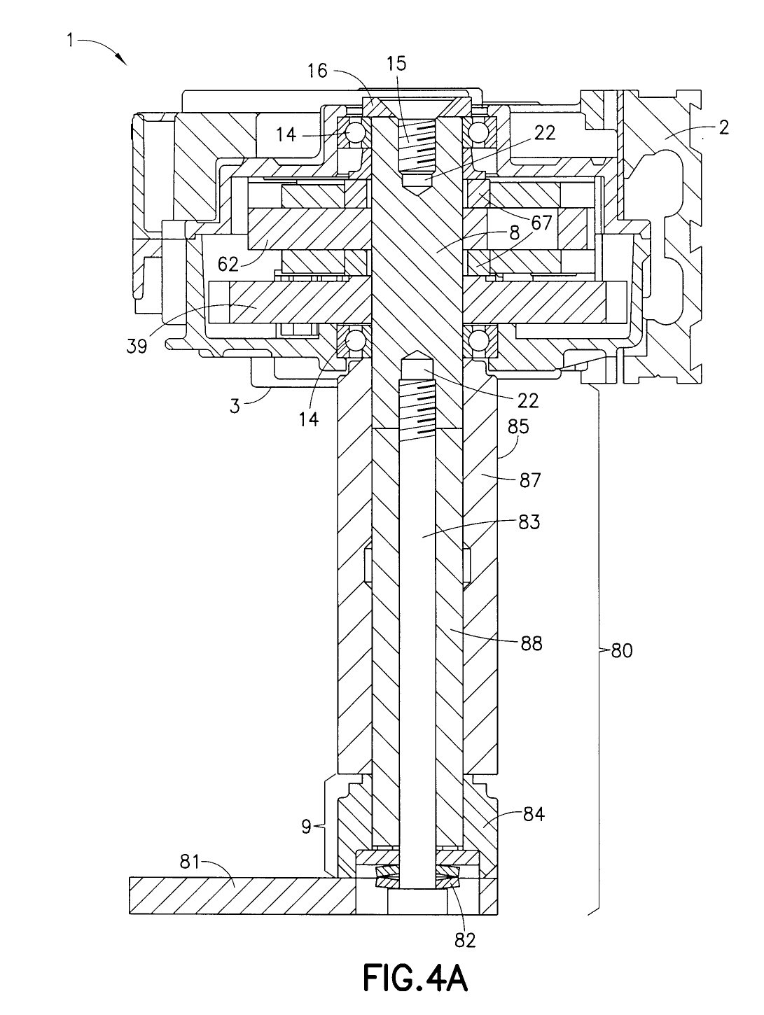

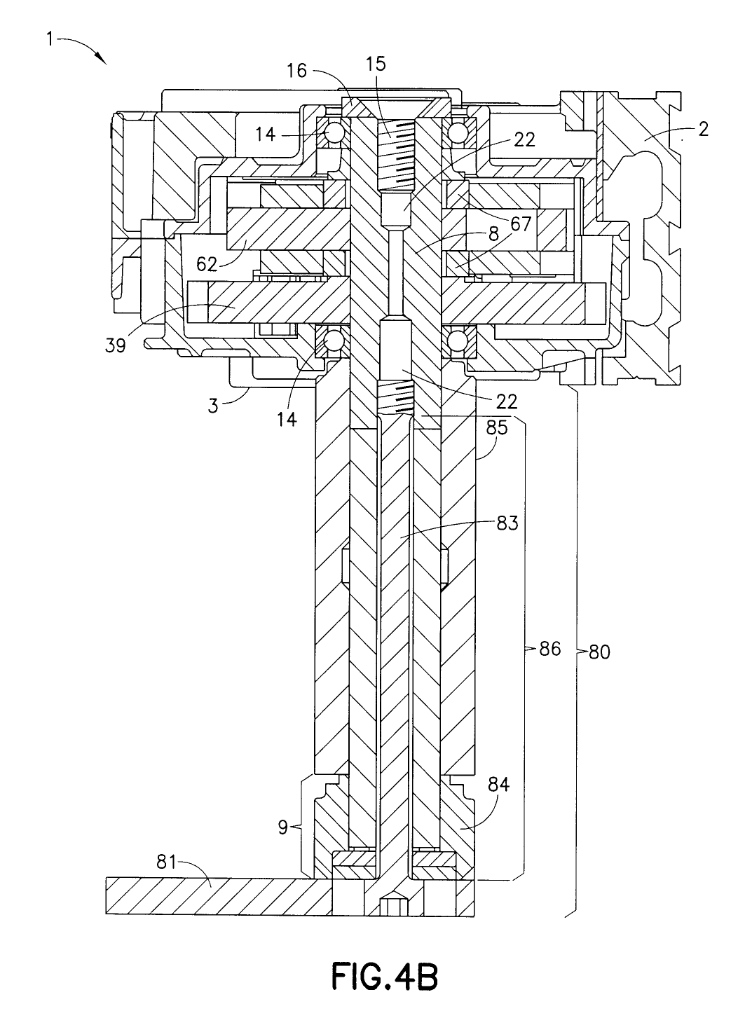

FIG. 4a shows the swing leaf actuator 1 in conjunction with an arm assembly 80. In other words, the lower screw 15 including associated cover part 16 of FIG. 3 have been removed. Instead, an extension piece 85, which is adjoined by an attachment part 84, is torque-proof placed upon the end of the output shaft 8, which exits vertically forward. With its head, a relatively long attachment screw 83 bears against a spring 82, which in turn bears against the side of the attachment part 84 facing away from the output shaft 8. The spring 82 reduces or even of totally the transmission of vibrations or oscillations at the swing leaf or at the swing leaf actuator 1 to the respective other component. The attachment screw 83 passes completely through the spring 82, the attachment part 84 and the extension piece 85 and is screwed into the internal thread portion 22 of the output shaft 8 facing said screw. A pivoting arm 81 of the arm assembly 80 is furthermore inserted between the head of the screw 83 and the attachment part 84, respectively the spring 82, and is thereby likewise immobilized by the screw 83 in a torque-proof manner with regard to the output shaft 8. As a result, it is possible for the swing leaf actuator 1, to rotate the pivoting arm 81 via the output shaft 8 and thus to pivot or to rotate the connected swing leaf. The swing leaf actuator 1 is affixed to a mounting plate 2 in a known manner, which in turn is affixed to a corresponding carrying body, such as the swing leaf, a door transom or the like. As can be seen, in this case, the reception space for a lubricant 17 or the like is omitted.

The spring 82 is preferably configured as a compression spring, and may be configured differently. In the illustrated embodiment, the spring is formed by two disc springs. Alternative shapes are for example coil springs, annular springs, evolute or volute springs, or pot-shaped springs. In the event vibrations or the like entail turning the screw 83 to a certain degree in the unscrewing direction, the screw 83 does not immediately lose its tightening function. Initially the spring 82 relaxes such that the thread of the screw 83 is still pressed against the corresponding internal thread portion 22 in longitudinal extension of the screw 83 and therefore the non-positive engagement between the screw 83 and the output shaft 8 is retained. As a result, the screw 83 continues to be able to immobilize the assembly arm respectively the pivot arm 81 and the extension piece 85 securely at the output shaft 8. Another advantage of this arrangement resides in the fact that the spring 82 presses the pivot arm 81 against the attachment part 84, respectively said two components 81, 84 against the extension piece 85 and therefore said three components 81, 84, 85 against the output shaft 8 and maintains their mutual operative connection for so long as its pretension is sufficient. In other words, on account of its pretension, the spring 82 already guarantees mutual engagement of the components 8, 81, 84, 85.

In the illustrated example, the extension piece 85 is preferably configured to be two pieces. It comprises an exterior bushing 87 with an interior bushing 88 received therein and is translationally movable along the longitudinal extension with regard to the exterior bushing. In this case, the exterior bushing 87 comprises, at least at its end facing the output shaft 8, an interior contour which is essentially complementary to the exterior contour of the output shaft 8, such that both components 8, 87, by positive engagement are disposed to be torque-proof with regard to each other. Accordingly, at its end facing the pivot arm 81, the interior bushing 88 has an exterior contour, which is essentially complementary to the interior contour of the attachment part 84.

In addition, the bushings 87, 88 may be likewise in mutual positive engagement, linked to the advantage that the bushings 87, 88 cannot rotate opposite each other, and in the extreme case they will be able to effect a torque transmission from the pivot arm 81 onto the output shaft 8 passing via the attachment part 84.

FIG. 4b shows the swing leaf actuator 1 of FIG. 4a provided with another type of screw connection. As can be seen, the spring 82 is omitted in this case. Instead thereof, the screw 83 is particularly configured, namely in the shape of an elastic screw. For this purpose, the elastic screw 83 is configured to be elastic in longitudinal direction in a section 86 between the screw head and the thread (neither of them is identified). This will allow for screwing the elastic screw 83 beyond the first tight screwing position, in which the screw 83 already reliably immobilizes the pivot arm 81 and the extension piece 85 at the output shaft 8, and is secured. During further screwing in, overtightening the screw 83, the latter will expand elastically in longitudinal direction. In the event the aforementioned vibrations or the like occur, the screw 83, namely the male thread thereof, is turned to a certain degree in the unscrewing direction and the screw 83 contracts again in the area of the section 86 in longitudinal direction such that the screw 83 continues to reliably immobilize the pivot arm 81 and the extension piece 85 at the output shaft 8.

As an alternative, the two variants shown in FIG. 4 could be combined, such that the screw head of the elastic screw 83 abuts against a spring 82.

FIG. 5 shows a modification of the swing leaf actuator 1 of FIG. 4a with the recess for lubricant 17. Furthermore, the extension piece 85 is omitted, such that in this case, the screw 15 immobilizes the attachment part 84 directly at the output shaft 8. For this purpose and similarly to FIG. 2g, the attachment part 84 has an interior contour complementary to the exterior contour of the output shaft 8 such as to reach a torque-proof engagement with the output shaft 8 when being pushed thereon.

As can be seen in FIG. 4 and FIG. 5, the extension piece 85, respectively the attachment part 84 of the above described embodiments, advantageously bears against the lower bearing 14, and preferably bears against the inner ring thereof, which is not identified and is in engagement with the output shaft 8. The reason for that is as follows: As the cam disc 62 is pressure-charged essentially perpendicularly to the axis of rotation of the output shaft 8 by the not visible pressure roller 61 in this case, on account of the likewise not visible spring 51 in this case, this circumstance results in increased friction, in particular adhesive friction between the output shaft 8 and the cam disc 62. This condition makes the translational movement of the output shaft 8 along its axis of rotation more difficult. In other words, relatively important forces are required in order to be able to displace the output shaft 8 in this condition translationally within the swing leaf actuator 1. As discussed above, the displacement of the output shaft 8 mainly serves the purpose of having the output shaft 8 protrude on the side to which the swing leaf actuator 1 is to be operatively connected to the respective swing leaf. When installing for example an arm assembly 80, the following happens as a result: The attachment part 84, respectively the extension piece 85 is pushed onto the output shaft 8, in this case from below. Thereupon, the screw 15, 83, with the components 81, 82 being located between the attachment part 84, respectively the extension piece 85 and the screw 15, 83, is placed such that the screw 15, 83 can be screwed into the facing internal thread portion 22 of the output shaft 8. During said screwing action, the attachment part 84, respectively the extension piece 85 reaches abutment with the facing side of the housing 3 of the swing leaf actuator 1, respectively with the facing bearing 14. During further screwing-in of the screw 83, the output shaft 8 is pulled downwards in this case, because the attachment part 84, respectively the extension piece 85 cannot move any more with regard to the housing 3. Now, in order to prevent the output shaft 8 from being pulled too far downwards, the screw 15 with the cover part 16 remains present in the upper portion. The cover part 16 therefore has the second function of an abutment with regard to the downward movement of the output shaft 8 in the swing leaf actuator 1.

Even though, compared to the state-of-the-art, an output shaft 8 can be configured shorter, this will still allow for the output shaft 8 to protrude far enough out in the direction of the operative connection such that in this case the extension piece 85 can be reliably brought into an operative engagement with the output shaft 8 and can be retained therein. The reason for that is as follows: In the illustrated pivot arm connection, when opening or closing the swing leaf, it might occur that the pivot arm 81, except for its rotating position, tends to change its other orientation with regard to the output shaft 8. The change may be that, for example on account of a not perfectly parallel alignment of a swing leaf upper edge with regard to the longitudinal extension of the swing leaf actuator 1, the pivot arm 81 is urged, from its parallel alignment with regard to the swing leaf actuator 1, into an acute alignment with regard to the operator. In other words, the pivot arm 81 threatens to “tilt off” with regard to the output shaft 8. Thus, a torque acts upon the pivot arm 81 about an axis, which does not extend parallel with regard to the axis of rotation of the output shaft 8, for example vertically thereto. In this case, there is the risk with the traditional square solution that the pivot arm 81 disconnects from the output shaft 8.

If the output shaft 8 projects sufficiently, the connecting portion 9 thereof may be configured higher in this case than it would be possible in the state-of-the-art on account of the desired height dimensions of the swing leaf actuator 1. Therefore, the surface is enlarged with which the output shaft 8, in this case with the extension piece 85, is able to be preferably also brought into a non-positive operative engagement, which circumstance increases the safety level for the torque transmission between the output shaft 8 and the extension piece 85, respectively the pivot arm 81, or guarantees said transmission at a higher safety level. In other words, the active surface of the output shaft 8 possibly serving as the press surface, can be preferably enlarged.

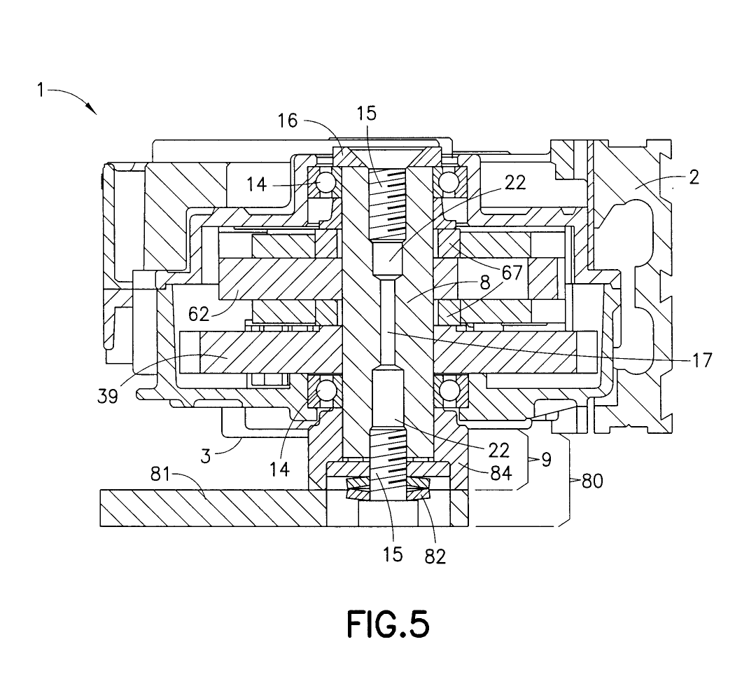

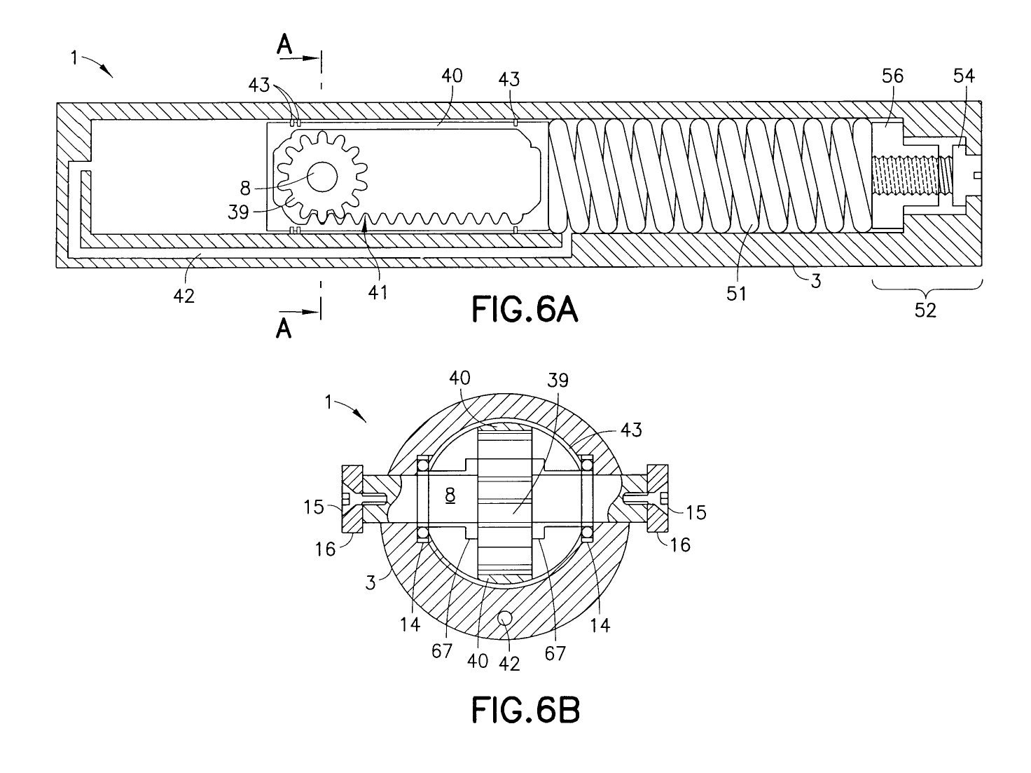

As an alternative, FIG. 6 shows a swing leaf actuator 1 configured as a door closer, one view in a longitudinal section (FIG. 6a) and one view in a section along a line A—A in FIG. 6a (FIG. 6b).

According to FIG. 6a, the door closer 1 is configured by way of example as based on a toothed rack. In other words, the door closer has a translationally movable piston 40 in the housing 3, which in this case in a lower area on a side facing the cylindrical gear 39, is provided with a toothing 41 that meshes with the cylindrical gear 39. By way of example, the guidance of the piston 40 is realized by sealing rings 43 disposed on the external circumference. This section of the piston 40 thus forms a toothed rack. In this case, on the right side, in a known manner, the piston 40 bears against a closer spring 51. Advantageously, the pretension of the closer spring can be adjusted again by an adjusting mechanism 52. A screw 54 is provided for this purpose, which is pressed against an inner side of the housing 3 by the closer spring 51 and passes through the housing 3. By rotating the screw 54, the spring abutment 56, which is translationally guided in the housing 3, is displaced and thereby the pretension of the closer spring 51 is modified. A hydraulic channel 42 connects the reception space for closer spring 51 to the housing space on the side of the closer spring 51 facing away from the piston 40.

In particular according to FIG. 6b, there is thus only one gear member provided on the output shaft 8, namely the cylindrical gear 39. Analogously to FIGS. 3 to 5, the output shaft 8, illustrated with its ends in a section, is again accommodated to be freely rotatably supported in the housing 3 by two bearings 14. In order to prevent the cylindrical gear 39 from moving along its axis of rotation, again spacers 67 are provided between the cylindrical gear 39 and the bearings 14, disposed spaced apart therefrom. Preferably the spacers 67 are clamped, respectively braced between the cylindrical gear 39 and the respective bearing 14, or they engage positively with the cylindrical gear 39 and/or with the bearing ring of the bearing 14, which is disposed in a torque-proof manner on the output shaft 8. If the output shaft 8 is not engaged with at least one bearing 14, the cylindrical gear 39 is thus prevented from changing its position such that the output shaft 8 cannot be pushed in any more. Into the ends, respectively into non-identified internal thread portions 22 of the output shaft 8, again screws 15 with cover parts 16 are screwed, which are illustrated in a sectional view.

The above described swing leaf actuators 1 allow for relatively simple methods to provide the respective swing leaf actuator 1 with an output shaft 8, and, if required, to operatively connect the former to a swing leaf, respectively to an interposed gear.

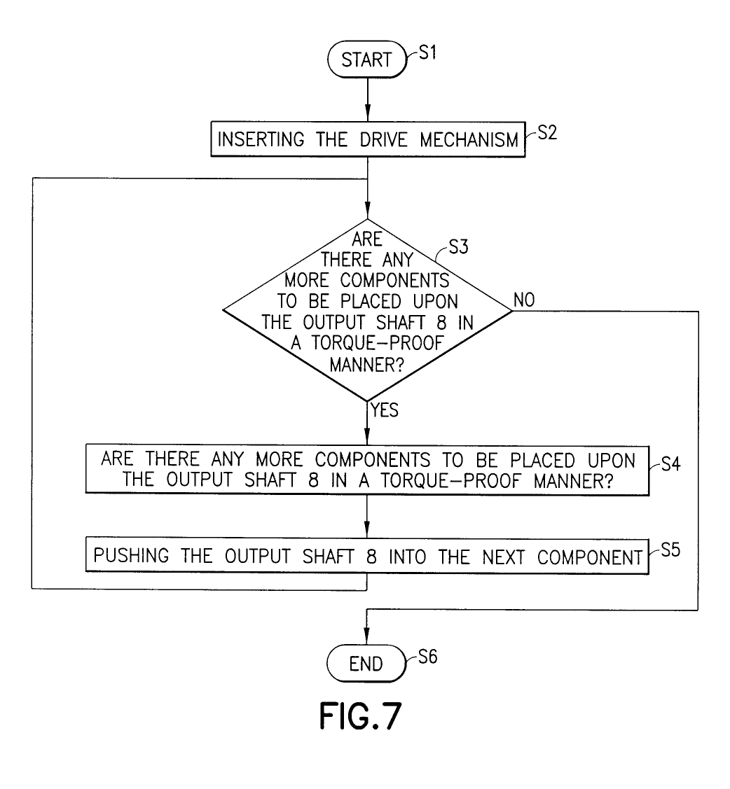

FIG. 7 illustrates such a method according to a first embodiment of the invention. Following the start of the installation in a step S1, the drive mechanism, comprising for example the drive portion 30 and the closer portion 50, is inserted into the swing leaf actuator 1 in a step S2. This insertion is realized in a way that both the components, to be disposed in a torque-proof manner on the output shaft 8, cannot be moved in a direction perpendicularly to their axis of rotation nor be charged by a load, and their axes of rotation are aligned with the axis of rotation of the output shaft 8 in the (not yet reached) installed condition. In case of a cam drive, just the cam disc 62 needs to be freed from the pressure charge of the pressure roller 61. This may be realized in that the closer spring 51 will not be inserted yet. As an alternative, the closer spring 51 is inserted in a way that it is not able to charge the cam plate carriage 57 with its spring energy.

The output shaft 8 is now pushed into the thus arranged components. In this case, in a step S3, it is verified whether or not the output shaft 8 still needs to be inserted into more components. If this is the case (YES branch following step S3), the output shaft 8 (including the already disposed components on the shaft in a torque-proof manner) is rotated, if required, in a following step S4 until the shaft can be inserted into the next component without any problem and can therefore be aligned with regard to said next component. Thereupon, the output shaft 8 is inserted into said next component in a following step S5. Thereafter, the method returns to step S3. If all the components are disposed on the output shaft in a torque-proof manner (NO branch following step S3), mounting the output shaft 8 is complete and mounting is terminated in a last step S6. This step may comprise for example screwing a screw 15 with cover part 16 into the output shaft 8.

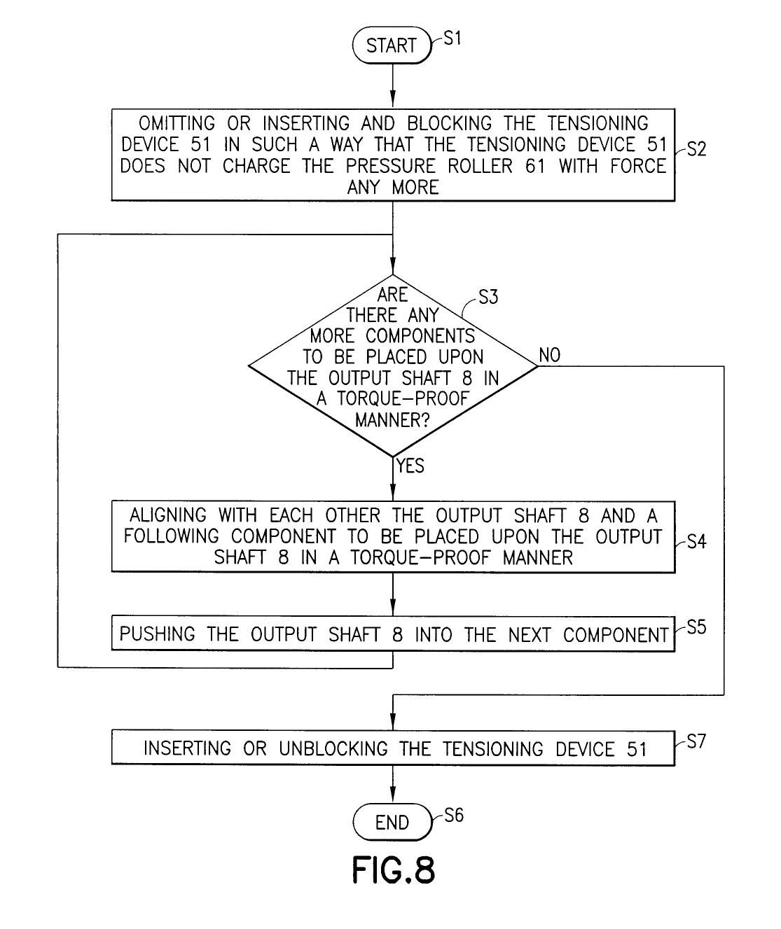

In case of a cam-based swing leaf actuator 1, the method may be modified as illustrated in FIG. 8. Step S2 may be modified in that the tensioning device for the pressure roller 61 (usually the aforementioned coil spring 51) is (initially) left out, namely is not installed, or else is installed in a way that it is prevented or blocked from charging the pressure roller 61 with its energy. This circumstance makes it easier to position the cam disc 62 for inserting the output shaft 8. Consequently, once the output shaft 8 is inserted into all the components, an additional step S7 is intended to either insert the tensioning device into the swing leaf actuator 1, respectively to unblock it such that the pressure roller 61 is urged against the cam disc 62.

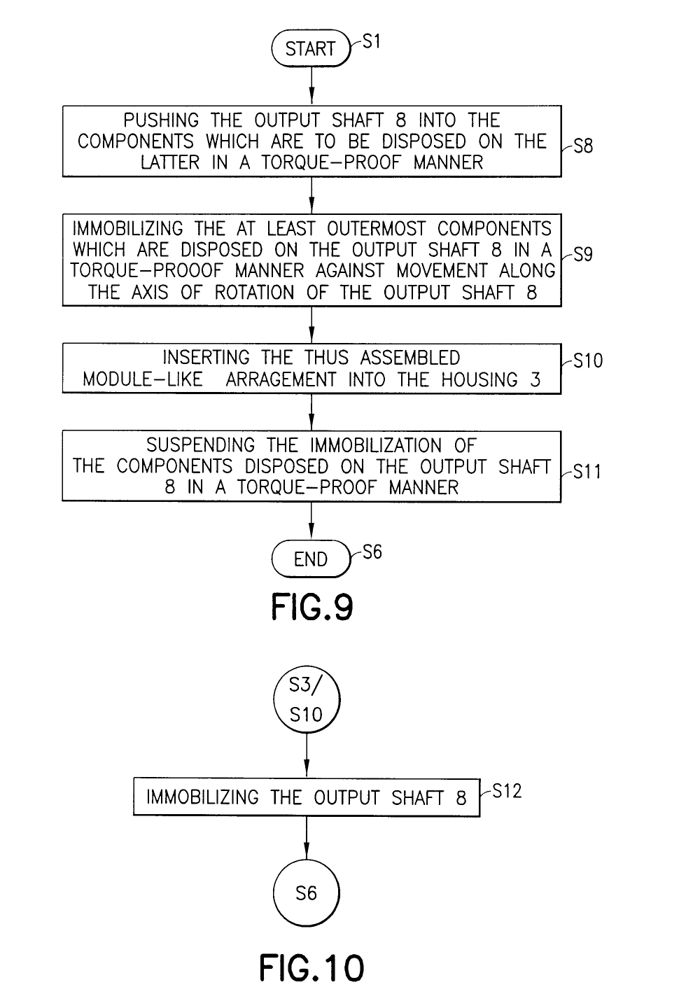

According to a mounting method according to a second embodiment of the invention shown in FIG. 9, the output shaft 8 is inserted in a step S8 into the components, which are to be affixed on the shaft in a torque-proof manner. In the following, at least the outermost components according to the preceding embodiments, namely the bearings 14, are blocked in a step S9 to a predetermined degree preferably temporarily against moving in relation to the output shaft 8 along the axis of rotation thereof. This action may be realized by clamping, which however makes the expenditure of force harder during a subsequent displacement of the output shaft 8, or by a clamping device for example in the shape of screws. As a result, a thus configured arrangement, as the thus configured drive module, can be completely inserted into the swing leaf actuator 1 in a subsequent step S10. In case of temporary immobilization, in a step S11, only said temporary immobilization is again suspended, in that the exemplary aforementioned clamping screw is being loosened or even removed.

According to FIG. 10, in all three described methods chronologically after mounting the output shaft 8 (NO branch following step S3), respectively after inserting the output module (Step S10), the output shaft 8 can be secured by the aforementioned screws 15 and cover parts 16 and/or a connected gear by way of example by the aforementioned arm assembly 80 in a step S12 additionally against a translational movement along its axis of rotation, and therefore can be immobilized in the swing leaf actuator 1. As a result, the swing leaf actuator 1 can be made ready for transporting purposes.

As explained above, the screws 15 and cover parts 16 serve the purpose of visually covering the output shaft 8. It may, however, be intended the cover parts 16 hold the output shaft 8 in its mounting position. If for example a pivot arm 81 is to be affixed after that, the opposite cover part 16 is exchanged for another, possibly flatter cover part. As a result, the other end of the output shaft 8, which is to be operatively connected to the pivot arm 81, can be moved out of the housing 3 to a degree required for the operative connection.

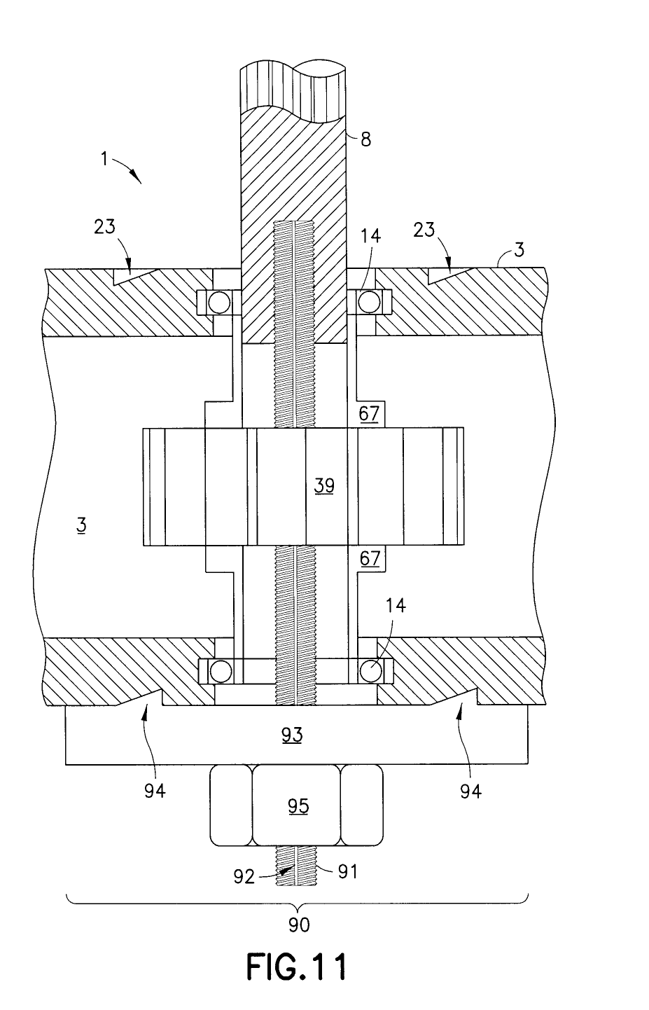

FIG. 11 shows a sectional view of the door closer 1 of FIG. 6 provided with a mounting device 90, according to a first embodiment of the invention.

The mounting device 90 comprises a threaded rod 91, which, in this case, is preferably screwed up to the abutment into the lower end of the output shaft 8, which is partly illustrated in a section and partly in a cut-away view. The threaded rod 91 is provided with a guide, which, in the illustrated example, has the shape of a groove 92 extending along the longitudinal extension of the threaded rod 91.

The mounting device 90 furthermore comprises a supporting element 93, in this case in the shape of a disc-like part, which, with regard to the door closer 1, is disposed in such a way that it is blocked against rotation in a first direction. In the illustrated example, this action is accomplished by serrated-shaped projections 94, which in this case protrude from the side facing the housing 3, and the points of the projections are oriented in the aforementioned first direction. Advantageously, the housing 3 has corresponding recesses 23, for example likewise serrated, the “points” thereof being oriented in the same first direction. The recesses 23 may be likewise configured as a rectangle. As a result, it is possible to insert the supporting element 93 with its projections 94 into the recesses 23, respectively to turn the element, until the projections are supported at the recesses 23 in the first direction.

By its guiding device 92, the threaded rod 91 is accommodated in the supporting element 93 to be translationally guided towards the housing 3 and away from the housing.

From the side facing away from the housing 3, a screw element, in this case in the shape of a hexagon nut 95, is screwed onto the threaded rod 91. If the screw 95 is turned in said first direction, the threaded rod 91 cannot rotate along on account of the longitudinal guide in the supporting element 93 and the blocked rotation of the supporting element 93 in this direction with regard to the housing 3. Instead, the nut 95 continues to be screwed further onto the threaded rod 91. If the nut 95 is in the position shown in FIG. 11, contacts the supporting element 93, the threaded rod 91 is thereby “screwed” or moved downwards in FIG. 11. As a result, the output shaft 8 is pulled by the threaded rod 91 in the direction of the nut 95 and therefore into the housing 3.

In the framework of the aforementioned methods, the following will happen: Provided both bearings 14 have an internal toothing, the output shaft 8 is initially moved as far into the housing 3 as reaching a point a bit above the top side of the upper bearing 14. If the teeth of the output shaft 8 and of the upper bearing 14 are not aligned such that they can be pushed into each other, in this case, the nut 95 can be turned to the left. Therefore, due to the longitudinal guide of the threaded rod 91 in the supporting element 93, the latter can be rotated along to the left. As a result, the output shaft 8 is rotated and the external toothing thereof changes its relative position with regard to the internal toothing of the upper bearing 14. If the teeth of the upper bearing 14 and of the output shaft 8 are aligned to each other such as to be able to push the output shaft 8 in, with some force the threaded rod 91 is likewise pulled downwards and the nut 95 is turned back to the right to the position shown in FIG. 11. In this case, the bearing ring, not identified in detail, of the upper bearing 14 is entrained. Upon further rotating the nut 95, the output shaft 8 is now “pulled into” the bearing 14. If the output shaft 8 reaches the area of the upper spacer 67, the overall procedure is repeated. The same applies to the other components 39, 67, and 14.

Aligning the teeth of the components 14, 67, 39, 67, 14 with regard to the output shaft 8 may be omitted, if, during installation, the components are positioned for example by color markings provided on them and on the rest of the swing leaf actuator 1, for example on the housing 3, such that they are correspondingly pre-positioned with regard to the output shaft 8. Then, after having placed the supporting element 93, just the nut 95 needs to be turned until the output shaft 8 has penetrated the lower bearing 14.

In this case, the recesses 23 are advantageously likewise configured on the upper side of the housing 3. This circumstance allows for placing the supporting element 93 also on this side, such that the output shaft 8 can be likewise installed from the bottom.

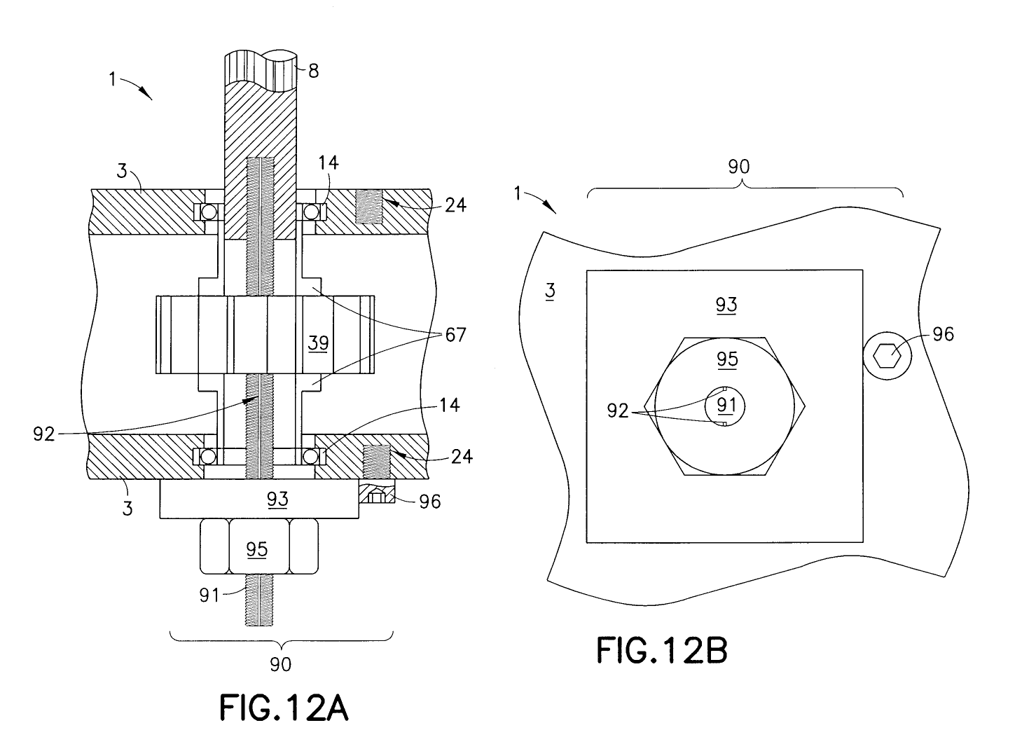

FIGS. 12a and 12b shows a mounting device 90 according to a second embodiment of the invention. FIG. 12a shows the mounting device 90 in a view like FIG. 11, and FIG. 12b shows the mounting device 90 from the bottom in FIG. 12a and enlarged. The difference to the previous embodiment mainly consists in the configuration of the supporting element 93 and of the housing 3. In this case, as can be seen, the projections 94 and the recesses 23 are omitted. Instead thereof, an abutment 96 is provided in the shape of a hexagon socket screw, which is preferably temporarily inserted into the housing 3 or is attached to it, in this case, namely screwed into an associated internal thread portion 24 of the housing 3. The cross-section of the supporting element 93 is configured to be non-round. By way of example, it has a square cross-section, as can be seen in FIG. 12b. The element is thus freely rotatable with regard to both the threaded rod 91 and the housing 3. In order to limit the rotation in the screw-in direction of the nut 95, namely clockwise according to FIG. 12b, the abutment 96 is provided, so that the output shaft 8 can be retracted by the nut 95 as indicated above. In particular in FIG. 12b, in this case, the two guiding grooves 92 can be seen, by which the threaded rod 91 is accommodated to be translationally guided in the supporting element 93.

FIG. 12 shows the mounting device 90 in a condition in which the supporting element 93 abuts against the abutment 96. In other words, when rotating the nut 95 further clockwise, the supporting element 93 cannot rotate along. On account of the guiding device in the supporting element 93, the threaded rod 91 cannot rotate along either and therefore pulls the output shaft 8 into the swing leaf actuator 1, in this case, from the top.

Preferably, likewise on the side facing away from the supporting element 93, the housing 3 has an internal thread portion 24. Therefore, it is possible to move the output shaft 8 for example likewise in the opposite direction, namely to the top in FIG. 12a.

If the nut 95 is rotated to the left, the supporting element 93 is entrained. As a result, the relative position of the output shaft 8 can be aligned with regard to components 14, 67, 39, which are still freely rotatable and are to be mounted in a torque-proof manner.

Initially the output shaft 8 is pushed into the components 14, 39, 67, prior to or after they have been already inserted into the swing leaf actuator 1, respectively into the housing 3 thereof. In the second case, this is advantageously realized by clamping all components 14, 39, 67 between the bearings 14 in that all components 14, 39, 67 are for example pressed against each other by a clamp or the like.

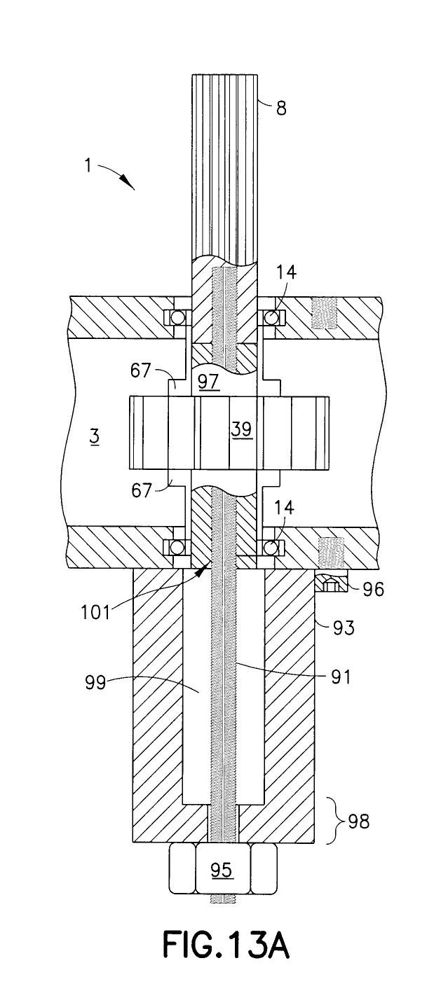

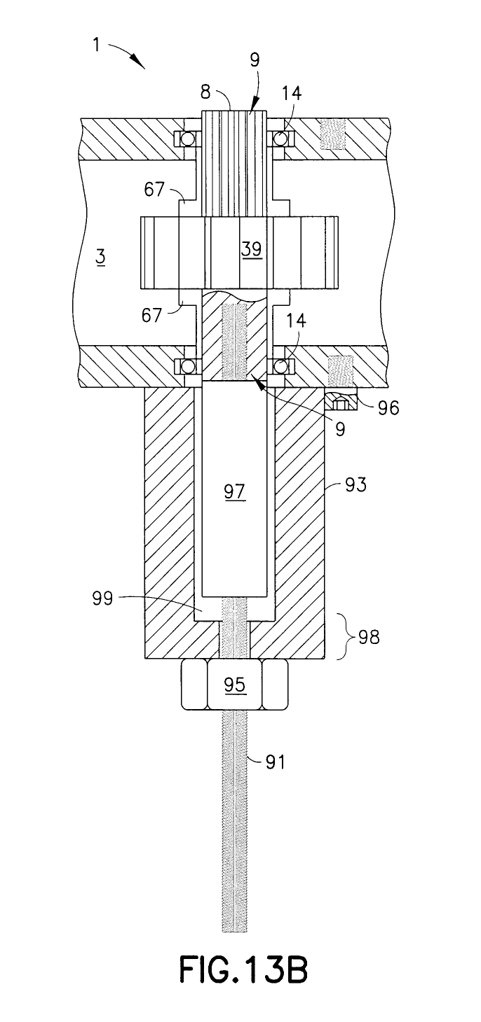

As an alternative, and according to FIG. 13, all components 14, 39, 67 are placed upon an assembly axle 97 which is easy to install in the swing leaf actuator 1. All components, in this case, in the shape of the bearings 14, 14, spacers 67, 67 and the cylindrical gear 39, which are to be placed on the output shaft 8 in a torque-proof manner, are placed respectively pushed on the assembly axle 97. The assembly axle 97 is configured in that all components 14, 39, 67 are positioned such that their axes of rotation align with each other. Furthermore, the assembly axle 97 is preferably configured for being inserted into the components 14, 39, 67 at lesser expenditure of force than compared to the output shaft 8. In FIG. 13a, the ends of the assembly axle 97 are illustrated in a section, recognized by the cross hatching.

The assembly axle 97 may have a circular cross-section. In other words, the components 14, 39, 67 do not need to be disposed in a torque-proof manner. This circumstance is advantageous in that, with the assembly axle 97 being inserted, the components 14, 39, and 67 can be rotated with regard to the latter and to each other.

It is furthermore preferred the assembly axle 97 does not have an internal thread, but a hollow space in the shape of a through-opening 101, through which the threaded rod 91 can pass.

During assembly, initially all components 14, 39, 67 are pushed onto the assembly axle 97. The thus configured module is inserted into the housing 3 of the swing leaf actuator 1. Now, the assembly axle 97 still needs to be replaced by the output shaft 8. For this purpose, the supporting element 93 is sleeve-like with a bottom 98 facing the nut 95.

The supporting element 93, again illustrated in a section, is hollow inside in the direction of the assembly axle 97 namely has a hollow inner space 99 pointing in the direction of the assembly axle 97. Thus, with the open end, the element bears against the housing 3 of the swing leaf actuator 1. The bottom 98 is preferably configured like the supporting element 93 illustrated in FIG. 12. The output shaft 8, which is illustrated partially and in a section at its end facing the supporting element 93, is placed against the assembly axle 97 from the side of the axle facing away from the supporting element 93.

During assembly, the threaded rod 91 is initially screwed into the output shaft 8 while passing through the assembly axle 97. If the assembly axle 97 does not have the internal thread, but only a hollow inner space 101, which in cross-section is large enough to accommodate the threaded rod 91, the latter does not have to be screwed through the assembly axle 97, but can be simply pushed through the axle 97.

Prior to or afterwards, the supporting element 93 is placed upon the housing 3, respectively the output shaft 8 in such a way that the bottom 98 thereof is located at the end facing away from the swing leaf actuator 1, or distal end of the supporting element 93. Thereupon, the nut 95 is screwed so far onto the end of the threaded rod 91 protruding from the supporting element 93 until the supporting element 93 comes to rest against the housing 3. Thereupon, retracting the output shaft 8 into the housing 3 is realized and the components 14, 39 and 67 follow in the aforementioned manner by continuing to turn the nut 95. In this case, the output shaft 8 gradually pushes the assembly axle 97 out of the components 14, 39 and 67 and into the hollow space 99 of the supporting element 93. In the event the torque-proof arrangement of the components 14, 39, 67 with regard to the assembly axle 97 is not given, the output shaft 8 together with the threaded rod 91 can be freely rotated and thus adjusted with regard to the respective following component 14, 39, and 67 which is to be accommodated in a torque-proof manner. FIG. 13a shows a condition, in which the output shaft 8 has already been moved through the, in this case, upper bearing 14 and partially likewise into the upper spacer 67.

Once the output shaft 8 is completely assembled, i.e. inserted into all the components 14, 39 and 67, as illustrated in FIG. 13b, the assembly axle 97 is free with regard to the swing leaf actuator 1 and is located within the supporting element 93.

Now, the threaded rod 91 needs to be screwed in the direction of the supporting element 93 and out of the output shaft 8. Thereupon, the threaded rod 91, the supporting element 93 and the assembly axle 97, which is located therein, can be simply removed and the swing leaf actuator 1 is ready for use.

The anti-rotation protection of the supporting element 93 with regard to the swing leaf actuator 1 is realized by the screw 95 by way of example. In other words, the supporting element 93 is shaped in that, at one point, it comes to rest against the nut 95 and cannot be rotated any further.

In FIG. 13b the output shaft 8 protrudes somewhat from the housing 3 to the top. In other words, in this condition, at its upper end, the output shaft 8 can be operatively coupled for example to a leaf arm assembly. In other words, said end and advantageously also the other end of the output shaft 8 simultaneously form respectively one connecting portion 9.

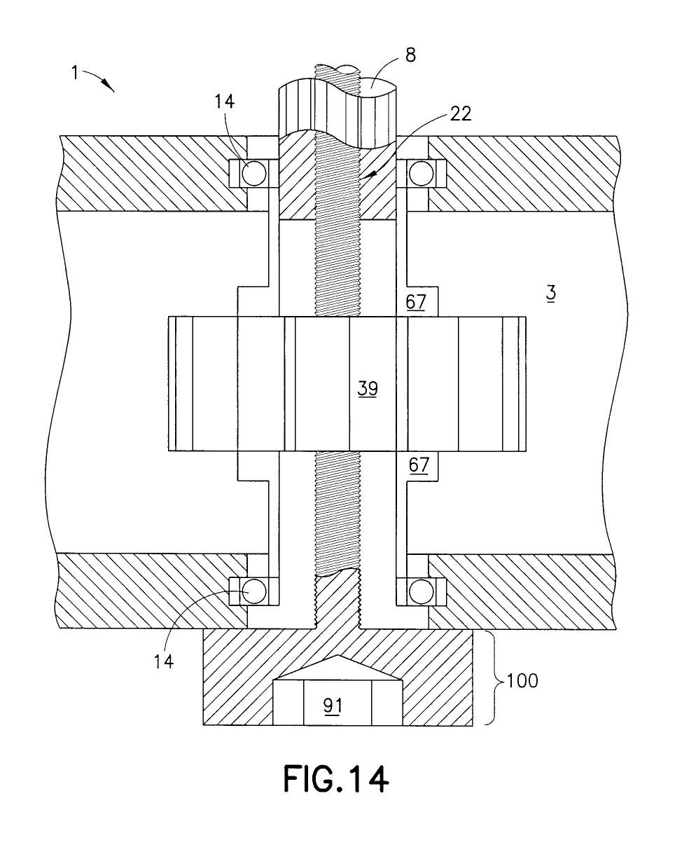

If the output shaft 8, as illustrated in FIG. 14, has a continuous internal thread 22, it may be provided to integrally configure the nut 95 with the threaded rod 91 or to dispose the nut in a torque-proof manner with regard to the rod. Instead, as illustrated in this case, the threaded rod 91, at its end facing away from the supporting element 93, may have a different screw section 100, illustrated in section, for example in the shape of a screw head. During assembly, the threaded rod 91 is screwed into the output shaft 8 by the nut 95 or the screw section 100. In this case, the shaft is not pulled into the components 14, 39, 67, but instead so to say “screwed in”. Finally, the threaded rod 91 just needs to be unscrewed from the output shaft 8, and the assembly is completed.

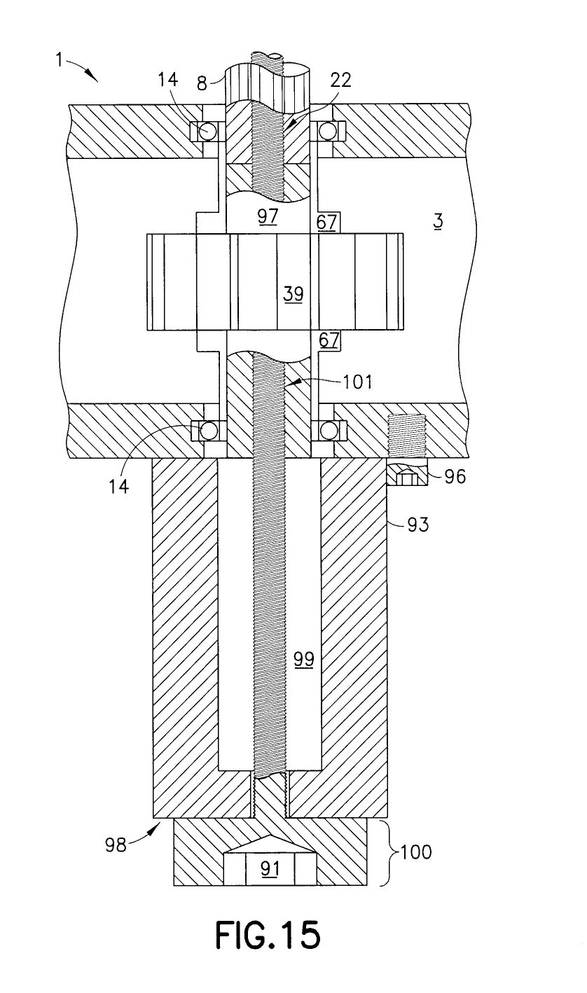

FIG. 15 shows a modification to FIG. 14. This modification is provided in the event an assembly axle 97 is utilized. It mainly differs in that again a sleeve-like supporting element 93 is utilized.

The arrangements, respectively mounting devices illustrated in FIG. 11 to FIG. 15, even after the initial mounting of the output shaft 8, may be utilized for translationally displacing the output shaft 8. This is for example the case, if the swing leaf actuator 1 is to be removed from a door and to be installed at a different door in such a way that the current end, which does not protrude, or is provided with a cover part 16, is to be operatively connected by way of example to the arm assembly 80.

In addition, they will allow for subsequent exchange of an already installed output shaft 8 for another output shaft, if the installed output shaft 8 needs to be replaced for example at the end of its lifespan or has become distorted under the action of forces, or has become unsuitable.

In the swing leaf actuators 1 illustrated in FIG. 11 and FIG. 12, the internal thread portion 22 would be drilled open for example such as to create a through-opening, which is aligned with the previously existing internal thread portion 22. In this case, the internal thread of the portion 22 can also be milled off.

In the swing leaf actuators 1 illustrated in the FIGS. 11, 12 and 14, a supporting element 93 would be utilized according to FIG. 13, respectively FIG. 15. In this case, the mounted output shaft 8 assumes the function of the above described assembly axle 97.

According to that, the threaded rod 91 is pushed through the supporting element 93 placed upon the housing 3. Furthermore, the rod is pushed through, respectively screwed into the mounted output shaft 8. The new output shaft to be inserted is preferably disposed, respectively placed at or onto the end of the output shaft 8 facing away from the supporting element 93.

If the threaded rod 91 already protrudes from the end of the mounted output shaft 8 facing the new output shaft, the new output shaft 8 is screwed onto the threaded rod 91. Otherwise, the threaded rod 91 can be screwed into the new output shaft. In both scenarios, an arrangement is created similar to FIG. 13a. The assembly axle 97 is just replaced by the output shaft 8 and displaced upwards in such a way that it is accommodated in all components 14, 39, and 67 in a torque-proof manner.

As a result, when continuing to screw the nut 95, respectively the screw portion 100, the new output shaft is gradually pulled, respectively screwed into the components 14, 39 and 67, and simultaneously the mounted output shaft 8 is urged, respectively moved in the direction of the inner space 99 of the supporting element 93. In other words, mounting the new output shaft is realized in the same way as mounting the output shaft 8 while utilizing the assembly axle 97.

In this case, an alignment device in the shape of a bushing can be provided, which, on the inside, is configured complementary to the exterior contour of the output shaft 8. This bushing is now placed onto the end of the installed output shaft 8 facing away from the supporting element 93. The new output shaft is inserted into the bushing. As a result, both output shafts 8 are already aligned with regard to each other in such a way that the new output shaft 8 can be simply moved into the components 14, 39 and 67. The installation is thereby extremely simplified.

In addition to the toothing 10, the end of the output shaft 8 may respectively have a specially configured connecting portion 9, for example in the shape of a square.

Instead of the toothing 10, the output shaft 8 may be configured differently for the positive engagement with the components 14, 39, 62, 67, 70, which are to be disposed thereon in a torque-proof manner. The shaft may have any possible non-circular cross-section. If the cross-section is circular, the axis of rotation intersects the cross-sectional surface off-center. The respective component, which is to be disposed in a torque-proof manner, therefore has such an exterior contour that finally the desired rotation of the respective components 14, 39, 62, 67, and 70 is achieved.

The external toothing, in particular visible in FIG. 2f, allows for the output shaft 8 to be disposed in very many relative positions with regard to the respective components 14, 39, 62, 67, and 70 to be disposed in a torque-proof manner, and to still maintain the positive engagement. As a result, the output shaft 8 can be installed and adapted in a very flexible manner at the respective swing leaf actuator 1.

The invention is not limited to the above embodiments.

Even if the invention has been mainly described in conjunction with a swing leaf actuator based on a toothed rack, it can be equally applied to any swing leaf actuator having a rotating output shaft.

Parts of the illustrated mounting devices 90 may be combined with each other and/or exchanged for each other. It is for example possible to provide the assembly axle 97 in all mounting devices; however, it may be omitted in all of them. The abutments 94, 23; 24 and 96 can be exchanged for each other or else they may be combined with each other. In addition, they may be provided in a way that rotating the supporting element 93 is limited likewise in the direction of rotation opposite to the one of the previous description. Apart from that, they may be configured in any known manner, which limits the rotation of the supporting element 93 at least in the direction the output shaft 8 is pulled in.

Instead of a screwing action, the threaded rod 91 can be clamped or pressure bonded to the output shaft 8.

Instead of a non-round configuration of the supporting element 93 for the purpose of delimiting the above described rotation, the supporting element 93 may have a through-opening, through which the associated screw 95 passes. Furthermore, preferably the through-opening has a cross-sectional shape of an oblong hole extending along a line of a circle, thus being arc-shaped. The center of a circle, which is thus defined by the central line of the oblong hole, corresponds to the center of rotation of the supporting element 93. As a result, the supporting element 93 can be freely rotated even with the screw 95 being inserted. The area of rotation of the supporting element 93 is limited by the oblong hole itself in conjunction with the screw 95, which passes through it.

As an alternative or in addition, the screws 95 may be replaced by bolts, which for example are stationary or inserted into the housing 3 for example by clamping, or else by headless screws.

In case of the headless screw, the latter may be screwed in already when mounting and is already present when (un)installing the output shaft 8. In addition the at least one internal thread portion 24, provided for this purpose, may be configured in that the associated headless screw can be countersunk. In other words, the screw can be screwed in as far as to terminate flush with the housing 3 on the outside or even to be deeper. For the purpose of (un)installing the output shaft 8, the respective headless screw is simply unscrewed somewhat from the housing 3.

As a result, the invention provides a very simple and effective solution to configure the output shaft 8 of a swing leaf actuator 1 independently from the other drive portions 30, 50 of a drive mechanism of the swing leaf actuator 1. Therefore, it is in particular possible to avoid expensive and complicated assembly steps, such as welding and the like, and to provide furthermore the advantage of being able to optimize the output shaft 8 with regard to its proper function, namely transmitting torques.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A swing leaf actuator, comprising:
an output shaft configured to be rotationally and operatively connected to a swing leaf that extends vertically with respect to a longitudinal extension of the swing leaf actuator disposed to be translationally movable in one or more components disposed on the output shaft in a torque-proof manner, at least at one end of the output shaft having a connecting portion; and
a drive mechanism having at least one drive portion comprising:
a gear component disposed on the output shaft in a torque-proof manner by which the drive mechanism is operatively connected to the output shaft to drives the output shaft rotationally in at least one direction.

2. The swing leaf actuator according to claim 1, wherein the torque-proof arrangement between the output shaft and the one or more components, which are disposed thereon is realized by positive engagement.

3. The swing leaf actuator according to claim 1, wherein the at least one drive portion comprises:
a cam disc configured as the gear component disposed on the output shaft in a torque-proof manner;
a pressure roller disposed to be freely rotatable and rotationally parallel with respect to the cam disc; and
a tensioning device that is operatively connected to the pressure roller such that the tensioning device urges the pressure roller perpendicularly with respect to an axis of rotation of the pressure roller against a running surface of the cam disc,
wherein the running surface of the cam disc is configured such that the pressure roller is able to effect a rotation of the cam disc because it is being urged against the running surface of the cam disc.

4. The swing leaf actuator according to claim 3, wherein the pressure roller is arranged to be freely rotatable in a transmission component that is disposed to be movable perpendicularly to an axis of rotation of the cam disc and translationally in a housing of the swing leaf actuator.

5. The swing leaf actuator according to claim 1, wherein the at least one drive portion is configured as a toothed rack comprising:
a toothed wheel configured as a gear component disposed on the output shaft in a torque-proof manner;
a piston accommodated in a housing of the swing leaf actuator and guided translationally and movable on the output shaft having a toothing portion along a path of movement that meshes with the toothed wheel; and
a tensioning device connected to the piston such that the tensioning device urges the piston in a direction of the output shaft or away from the output shaft.

6. The swing leaf actuator according to claim 1, wherein the at least one drive portion forms a second of the at least one drive portion, and comprises a motor connected to an associated gear component disposed on the output shaft in a torque-proof manner,
wherein the second of the at least one drive portion is driven by the motor in at least one direction of rotation.

7. The swing leaf actuator according to claim 6, wherein the second of the at least one drive portion and the at least one drive portion are operatively connected to the output shaft such that they drive the output shaft in opposite directions of rotation with respect to each other.

8. The swing leaf actuator according to claim 4, wherein the transmission component bypasses the output shaft such that the pressure roller is disposed at a side of the cam disc facing away from the tensioning device.

9. The swing leaf actuator according to claim 8, wherein at least one of the transmission component and the cam disc is disposed respectively with at least one portion between the components of the drive portions.

10. The swing leaf actuator according to claim 1, wherein the one or more components, disposed on the output shaft in a torque-proof manner, are accommodated in a housing of the swing leaf actuator to be freely rotatable and stationary in a direction parallel with regard to an axis of rotation of the output shaft.

11. The swing leaf actuator according to claim 10, wherein the stationary accommodation of the one or more components is realized by bearing parts disposed stationarily in the housing of the swing leaf actuator, and between which the one or more components disposed on the output shaft in a torque-proof manner, are disposed to be freely rotatable.

12. The swing leaf actuator according to claim 7, further comprising at least one spacer disposed between two components disposed on the output shaft in a torque-proof manner.

13. The swing leaf actuator according to claim 1, wherein,
the output shaft an exterior contour of the output shaft has a changing distance to the center of rotation of the output shaft along an axis of rotation of the output shaft, and
wherein the gear component comprises a cylindrical gear and a cam disc disposed on the output shaft in a torque-proof manner each have a respective interior contour configured such that the respective interior contour is positively engaged in the exterior contour of the output shaft, such that the respective component is disposed to be torque-proof with regard to the output shaft.

14. The swing leaf actuator according to claim 1, further comprising a screw and a cover part configured to releasably immobilize the output shaft with respect to a movement along its axis of rotation.

15. The swing leaf actuator according to claim 1, further comprising:
an attachment device having a screw by which at least one torque transmitting component is affixed to the output shaft in a torque-proof manner such that, when rotating the screw in an unscrewing direction up to a predetermined degree, the at least one torque transmitting component is restrained by the screw to be disposed at the output shaft in a torque-proof manner.

16. A method for mounting a swing leaf actuator comprising:
inserting a drive mechanism into a housing of the swing leaf actuator; and
for each of a plurality of components to be disposed on an output shaft of the drive mechanism in a torque-proof manner:
aligning the output shaft and each of the plurality of components with respect to each other such that the output shaft is pushed into the respective component, and
inserting the output shaft into each of the plurality of components along an axis of rotation of the output shaft,
whereby the output shaft and each of the plurality of components are simultaneously disposed to be torque-proof with respect to each other.

17. The method according to claim 16, wherein the swing leaf actuator the drive mechanism has at least one drive portion that includes a cam disc configured as the gear component disposed on the output shaft in a torque-proof manner, a pressure roller disposed to be freely rotatable and rotationally parallel with respect to the cam disc, and a tensioning device that is operatively connected to the pressure roller such that the tensioning device urges the pressure roller perpendicularly with respect to an axis of rotation of the pressure roller against a running surface of the cam disc, wherein the running surface of the cam disc is configured such that the pressure roller is able to effect a rotation of the cam disc because it is being urged against the running surface of the cam disc, the method further comprising:
following the inserting, inserting a tensioning device into the drive mechanism such that the tensioning device urges the pressure roller against the cam disc,
wherein inserting the drive mechanism into the housing prevents the tensioning device from urging the pressure roller against the cam disc.

18. The method for mounting a swing leaf actuator according to claim 17 further comprises:
pushing the output shaft into each of the plurality of components, which are to be disposed thereon in a torque-proof manner such that the output shaft and each of the plurality of components are simultaneously disposed with regard to each other in a torque-proof manner; and
immobilizing the components of each of the plurality of components disposed the furthest to the outside up to a predetermined degree against moving in relation to the output shaft along the axis of rotation of the output shaft, whereby a drive module is formed; and
inserting the drive module into the swing leaf actuator.

19. The method according to claim 18, further comprising:
inserting the drive module into the swing leaf actuator; and
suspending the immobilization of the components, which are disposed the furthest to the outside, against moving in relation to the output shaft along the axis of rotation of the output shaft.

20. The method according to claim 19, further comprising releasably immobilizing the output shaft against a translational movement of the output shaft along its axis of rotation.

21. The method according to claim 18, further comprising providing a device configured to
align the output shaft with regard to each of the plurality of components which are to be disposed thereon in a torque-proof manner, in such a way that the output shaft can be pushed into the respective component, and
following the alignment, to push, respectively to move the output shaft through each of the plurality of components.
